(19) United States
(12) Patent Application Publication
(10) Pub. No.: US 2013/0292300 A1
(43) Pub. Date: Nov. 7, 2013

(54) MESOSTRUCTURED ZEOLITIC MATERIALS SUITABLE FOR USE IN HYDROCRACKING CATALYST COMPOSITIONS AND METHODS OF MAKING AND USING THE SAME

(71) Applicant: Massachusetts Institute of Technology, Cambridge, MA (US)

(72) Inventors: Jackie Y. Ying, Winchester, MA (US); Javier Garcia-Martinez, Alicante (ES)

(21) Appl. No.: 13/937,721

(22) Filed: Jul. 9, 2013

Related U.S. Application Data
(63) Continuation-in-part of application No. 12/505,843, filed on Jul. 20, 2009.
Application No. 12/505,843 is a division of application No. 10/830,714, filed on Apr. 23, 2004, now Pat. No. 7,589,041.

(51) Int. Cl. C10G 47/20; B01J 29/16

(52) U.S. Cl. CPC C10G 47/20; B01J 29/166
USPC 208/97; 208/111.3

(57) ABSTRACT

Hydrocracking processes and catalyst composition for use therein are provided. The catalyst compositions described herein include a mesoporous support material and at least one catalytic metal supported thereon. The mesoporous support material may comprise a single-phase crystalline mesostructured zeolite. Additionally, the mesoporous structure may exhibit long range crystallinity and include a plurality of mesopores defined within of the volume of the crystalline mesostructure. Suitable feedstocks for the hydrocracking processes according to embodiments of the present invention crude oil, a gas oil fraction, vacuum gas oil, and combinations thereof.

### CROSS-REFERENCE TO RELATED APPLICATIONS

This application is a continuation-in-part of U.S. application Ser. No. 12/505,843, filed Jul. 20, 2009, which is a divisional of U.S. application Ser. No. 10/830,714, filed on Apr. 23, 2004, now U.S. Pat. No. 7,589,041, the entire disclosures of which are incorporated herein by reference.

### GOVERNMENT FUNDING

This invention was made with support under Grant Number DAAD19-02-D0002, awarded by the Army Research Office; the government, therefore, has certain rights in the invention.

### BACKGROUND

1. Field

One or more embodiments of the present invention relate to mesostructured zeolites, methods for preparing catalyst compositions from mesostructured zeolites, and methods of using the catalyst compositions. More particularly, embodiments described herein relate to catalyst compositions that include a catalyst support formed from a mesostructured zeolite and use of such compositions in a hydrocracking process.

2. Description of Related Art

Zeolites and related crystalline molecular sieves are widely used due to their regular microporous structure, strong acidity, and ion-exchange capability. van Bekkum, H., Flanigen, E. M., Jacobs, P. A., Jansen, J. C. (editors), Introduction to Zeolite Science and Practice, 2nd edition. Studies in Surface Science and Catalysis, Vol. 137 (2001); Corma, A., Chem. Rev., 1997, 97, 2373-2419; Davis, M. E., Nature, 2002, 417, 813-821. However, their applications are limited by their small pore openings, which are typically narrower than 1 nm. The discovery of MCM-41, with tuneable mesopores of 2-10 nm, overcomes some of the limitations associated with zeolites. Corma, A., Chem. Rev., 1997, 97, 2373-2419; Kresge, C. T., et al., Nature, 1992, 259, 710-712; Kosslick, H., et al., Appl. Catal. A: Gen., 1999, 184, 49-60; Linssen, T., Cassiers, K., Cool, P., Vansant, E. F., Adv. Coll. Interf. Sci., 2003, 103, 121-147. However, unlike zeolites, MCM-41-type materials are not crystalline, and do not possess strong acidity, high hydrothermal stability and high ion-exchange capability, which are important for certain catalytic applications. Corma, A., Chem. Rev., 1997, 97, 2373-2419.

Over the past 10 years, a great deal of effort has been devoted to understanding and improving the structural characteristics of MCM-41. It was found that the properties of Al-MCM-41 could be improved through (i) surface silylation, (ii) Al grafting on the pore walls to increase acidity, (iii) salt addition during synthesis to facilitate the condensation of aluminosilicate groups, (iv) use of organics typically employed in zeolite synthesis to transform partially the MCM-41 wall to zeolite-like structures, (v) preparation of zeolite/MCM-41 composites, (vi) substitution of cationic surfactants by tri-block copolymers and Gemini amine surfactants to thicken the walls, and (vii) assembly of zeolite nanocrystals into an ordered mesoporous structure. Liu, Y., Pinnavaia, T. J., J. Mater. Chem., 2002, 12, 3179-3190. In the latter approach, Liu et al. were able to prepare the first steam-stable hexagonal aluminosilicate (named MSU-S) using zeolite Y nanoclusters as building blocks. Pentasil zeolite nanoclusters were also used to produce MSU-S_{(MFI)} and MSU-S_{(BEA)}).

Some strategies have managed to improve appreciably the acidic properties of Al-MCM-41 materials. Liu, Y., Pinnavaia, T. J., J. Mater. Chem., 2002, 12, 3179-3190; van Donk, S., et al., Catal. Rev., 2003, 45, 297-319; Kloetstra, K. R., et al., Chem. Commun., 1997, 23, 2281-2282; Corma, A., Nature, 1998, 396, 353-356; Karlsson, A., et al., Microporous Mesoporous Mater., 1999, 27, 181-192; Jacobsen, C. J. H., et al., J. Am. Chem. Soc., 2000, 122, 7116-7117; Huang L., et al., J. Phys. Chem. B., 2000, 104, 2817-2823; On, D. T., et al., Angew. Chem. Int. Ed., 2001, 17, 3248-3251; Liu, Y., et al., Angew. Chem. Int. Ed., 2001, 7, 1255-1258. However, due to the lack of long-range crystallinity in these materials, their acidity was not as strong as those exhibited by zeolites. Corma, A., Chem. Rev., 1997, 97, 2373-2419. For example, semicrystalline mesoporous materials, such as nanocrystalline aluminosilicate PNAs and Al-MSU-S_{(MFI)}, even being more active than conventional Al-MCM-41, showed significantly lower activity than H-ZSM-5 for cumene cracking; the catalyst activity for this reaction has usually been correlated to the Bronsted acid strength of the catalyst. Corma, A., Chem. Rev., 1997, 97, 2373-2419; Liu, Y., Pinnavaia, T. J., J. Mater. Chem., 2002, 12, 3179-3190; Kloetstra, K. R., et al., Chem. Commun., 1997, 23, 2281-2282; Jacobsen, C. J. H., et al., J. Am. Chem. Soc., 2000, 122, 7116-7117.

Previous attempts to prepare mesostructured zeolitic materials have been ineffective, resulting in separate zeolitic and amorphous mesoporous phases. Karlsson, A., et al., Microporous Mesoporous Mater., 1999, 27, 181-192; Huang L., et al., J. Phys. Chem. B., 2000, 104, 2817-2823. Moreover, some authors pointed out the difficulty of synthesizing thin-walled mesoporous materials, such as MCM-41, with zeolitic structure, due to the surface tension associated with the high curvature of the mesostructure. Liu, Y., Pinnavaia, T. J., J. Mater. Chem., 2002, 12, 3179-3190. Thus, the need exists for zeolite single crystals with ordered mesoporosity, and methods of making and using them.

### SUMMARY

In one embodiment, the present invention concerns hydrocracking process comprising contacting a hydrocarbon-containing feedstock with a catalyst composition under hydrocracking conditions to thereby produce a hydrocracked product, wherein the catalyst composition comprises a mesoporous support material and at least one catalytic metal supported on the mesoporous support material, wherein the mesoporous support material comprises a mesostructured crystalline inorganic one-phase hybrid single crystal material having long-range crystallinity and comprising a plurality of mesopores.

In another embodiment, the present invention concerns a hydrocracking process comprising contacting an organic feedstock with a catalyst composition in the presence of hydrogen under hydrotreating conditions to thereby produce a hydrotreated product, wherein said catalyst composition comprises at least one catalytic component supported on a zeolitic support material, wherein said zeolitic support material comprises a single-phase crystalline mesostructured zeolite comprising a plurality of mesopores defined within of the volume of the crystalline mesostructure of said zeolite.

In another aspect, the present invention relates to a crystalline inorganic material organized in a mesostructure. In a further embodiment, the inorganic material is a metal oxide. In a further embodiment, the inorganic material is a zeolite. In a further embodiment, the inorganic material is a zeotype. In a further embodiment, the inorganic material has a faujasite, mordenite, or ZSM-5 (MFI) structure. In a further embodiment, the mesostructure has the hexagonal pore arrangement of MCM-41. In a further embodiment, the mesostructure has the cubic pore arrangement of MCM-48. In a further embodiment, the mesostructure has the lamellar pore arrangement of MCM-50. In a further embodiment, the mesostructure has pores organized in a foam arrangement. In a further embodiment, the mesostructure has randomly placed pores.

In a further embodiment, the mesostructure is a one dimensional nanostructure. In a further embodiment, the nanostructure is a nanotube, nanorod, or nanowire.

In a further embodiment, the mesostructure is a two dimensional nanostructure. In a further embodiment, the nanostructure is a nanoslab, nanolayer, or nanodisc.

In a further embodiment, the crystalline inorganic material is Y[MCM-41], MOR[MCM-41], or ZSM-5[MCM-41].

In a further embodiment, the mean pore diameter within the mesostructure is about 2 to about 5 nm. In a further embodiment, the mean pore diameter within the mesostructure is about 2 to about 3 nm. In a further embodiment, the wall thickness within the mesostructure is about 1 to about 5 nm. In a further embodiment, the wall thickness within the mesostructure is about 1 to about 3 nm.

In another aspect, the present invention relates to a method of preparing a mesostructured zeolite comprising: a) adding a zeolite to a medium comprising an acid or base, and optionally a surfactant; b) adding a surfactant to the medium from step a) if it is not there already; c) optionally adding a swelling agent to the medium from step b); d) optionally hydrothermally treating the medium from step b) or c); and e) washing and drying the resulting material.

In a further embodiment, the resulting material is further calcined at elevated temperatures. In a further embodiment, the calcination step is performed in air or oxygen. In a further embodiment, the calcination step is performed in an inert gas. In a further embodiment, the inert gas is N₂. In a further embodiment, the maximum elevated temperatures are at about 500 to 600° C. In a further embodiment, the maximum elevated temperatures are at about 550° C.

In a further embodiment, the zeolite is selected from the group consisting of faujasite (FAU), mordenite (MOR), and ZSM-5 (MFI). In a further embodiment, the medium in step a) comprises a base. In a further embodiment, the base is an alkali hydroxide, alkaline earth hydroxide, NH₄OH or a tetralkylammonium hydroxide. In a further embodiment, the base is NaOH, NH₄OH, or tetramethylammonium hydroxide. In a further embodiment, the medium in step a) comprises an acid. In a further embodiment, the acid is HF. In a further embodiment, the surfactant is an alkylammonium halide. In a further embodiment, the surfactant is a cetyltrimethylammonium bromide (CTAB) surfactant. In a further embodiment, hydrothermally treating the medium from step b) or c) occurs at about 100 to about 200° C. In a further embodiment, hydrothermally treating the medium from step b) or c) occurs at about 120 to about 180° C. In a further embodiment, hydrothermally treating the medium from step b) or c) occurs at about 140 to about 160° C. In a further embodiment, hydrothermally treating the medium from step b) or c) occurs at about 150° C. In a further embodiment, hydrothermally treating the medium from step b) or c) takes place overnight. In a further embodiment, hydrothermally treating the medium from step b) or c) takes place over about 20 hours.

In another aspect, the present invention relates to a mesostructured zeolite prepared by any of the aforementioned methods.

In another aspect, the present invention relates to a method of preparing a mesostructured zeolite comprising: a) adding a zeolite in its acidic form to a medium comprising a base, and optionally a surfactant, in which the zeolite is partially dissolved to produce a suspension; b) adding a surfactant to the medium from step a) if it is not there already; c) optionally adding a swelling agent to the medium from step b); d) optionally hydrothermally treating the medium from step b) or c); e) washing and drying the resulting material; and f) removing the surfactant from the resulting material either by calcining at elevated temperatures, or by solvent extraction.

In another aspect, the present invention relates to a mesostructured zeolite prepared by the above method, wherein the mesostructured zeolite is in the form of a nanotube, nanorod, or nanowire.

In another aspect, the present invention relates to a mesostructured zeolite prepared by the above method, wherein the mesostructured zeolite is in the form of a nanoslab, nanolayer, or nanodisc.

In another aspect, the present invention relates to a method of anchoring a positively charged chemical species to a mesostructured zeolite comprising contacting the mesostructured zeolite and the positively charged species in a medium. In a further embodiment, the positively charged species is selected from the group consisting of cations of an element, quaternary amines, ammonium ions, pyridinium ions, phosphonium ions, and mixtures thereof.

In another aspect, the present invention relates to a method of anchoring a chemical species to a mesostructured zeolite comprising: contacting the mesostructured zeolite in its acidic form and a basic chemical species in a medium. In a further embodiment, the basic chemical species is an inorganic base or an organic base. In a further embodiment, the basic chemical species is selected from the group consisting of hydroxide, amine, pyridine, phosphine, and mixtures thereof.

In another aspect, the present invention relates to a method of anchoring a homogeneous catalyst on a mesostructured zeolite comprising: contacting a mesostructured zeolite comprising a chemical species anchored on it, and a homogeneous catalyst in a medium, wherein the anchored chemical species is capable of acting as a ligand to the homogeneous catalyst.

In another aspect, the present invention relates to a method of supporting a heterogeneous catalyst on a mesostructured zeolite comprising contacting the mesostructured zeolite and the heterogeneous catalyst by a method selected from the group consisting of physical mixture, dry impregnation, wet impregnation, incipient wet impregnation, ion-exchange, and vaporization. In a further embodiment, the heterogeneous catalyst comprises a metal or a mixture thereof. In a further embodiment, the heterogeneous catalyst comprises a metal oxide or a mixture thereof. In a further embodiment, the heterogenous catalyst comprises a nanoparticle, cluster, or colloid.

In another aspect, the present invention relates to a method of catalytically cracking an organic compound comprising contacting the organic compound with a mesostructured zeolite. In a further embodiment, the organic compound is a hydrocarbon. In a further embodiment, the organic compound is an unsaturated hydrocarbon. In a further embodiment, the organic compound is an aromatic hydrocarbon. In a further embodiment, the organic compound is an alkylated benzene. In a further embodiment, the organic compound is 1,3,5-triisopropyl benzene. In a further embodiment, the organic compound is crude oil. In a further embodiment, the organic compound is gas-oil. In a further embodiment, the organic compound is vacuum gas oil. In a further embodiment, the mesostructured zeolite has the zeolitic structure of a faujasite (FAU), mordenite (MOR), or ZSM-5 (MFI). In a further embodiment, the mesostructured zeolite has the hexagonal pore arrangement of MCM-41. In a further embodiment, the mesostructured zeolite is Y[MCM-41], MOR[MCM-41], or ZSM-5[MCM-41].

In another aspect, the present invention relates to a method of refining crude oil comprising contacting the crude oil with a mesostructured zeolite. In a further embodiment, the contacting of the oil with the mesostructured zeolite takes place within a Fluid Catalytic Cracking Unit. In a further embodiment, production of gasoline is increased relative to the amount of gasoline produced in the absence of the mesostructured zeolite. In a further embodiment, production of light olefins is increased relative to the amount of light olefins produced in the absence of the mesostructured zeolite.

In another aspect, the present invention relates to a method of catalytically degrading a polymer comprising contacting the polymer with a mesostructured zeolite. In a further embodiment, the polymer is a hydrocarbon polymer. In a further embodiment, the polymer is a poly(alkylene), poly(alkynyl) or poly(styrene). In a further embodiment, the polymer is polyethylene (PE). In a further embodiment, the mesostructured zeolite has the zeolitic structure of a faujasite (FAU), mordenite (MOR), or ZSM-5 (MFI). In a further embodiment, the mesostructured zeolite has the hexagonal pore arrangement of MCM-41. In a further embodiment, the mesopostructured zeolite is Y[MCM-41], MOR[MCM-41], or ZSM-5[MCM-41].

These embodiments of the present invention, other embodiments, and their features and characteristics, will be apparent from the description, drawings and claims that follow.

### BRIEF DESCRIPTION OF THE DRAWINGS

Embodiments of the present invention are described herein with reference to the following drawing figures, wherein:

FIG. 1 depicts the X-ray diffraction pattern of the mesostructured zeolite H-Y[MCM-41]. Both the ordered mesostructure (reveled by the XRD peaks at low angles) and the zeolitic crystalline structure are present;

FIG. 2 depicts the X-ray diffraction pattern of the mesostructured zeolite H-MOR[MCM-41]. Both the ordered mesostructure (reveled by the XRD peaks at low angles) and the zeolitic crystalline structure are present;

FIG. 3 depicts the X-ray diffraction pattern of the mesostructured zeolite H-ZSM-5[MCM-41]. Both the ordered mesostructure (reveled by the XRD peaks at low angles) and the zeolitic crystalline structure are present;

FIG. 4 depicts FTIR characterization peaks for MCM-41, zeolite Y, and Meso H-Y;

FIG. 5 depicts FTIR spectra of H-Y[MCM-41] (top), H-MOR[MCM-41] (middle), H-ZSM-5[MCM-41] (bottom) and their zeolitic versions. A match between each mesostructured zeolite and its corresponding zeolite is observed, indicating the fully zeolitic connectivity present in mesostructured zeolites;

FIG. 6 depicts the physisorption isotherm of N₂ at 77 K of H-Y[MCM-41] and its zeolitic version. The pore size distribution (BJH method) of the mesostructured zeolite is included in inset. The presence of well developed narrow pore size mesoporosity in the mesolitic sample is evident;

FIG. 7 depicts the physisorption isotherm of N₂ at 77 K of H-MOR[MCM-41] and its zeolitic version. The pore size distribution (BJH method) of the mesostructured zeolite is included in inset. The presence of well developed narrow pore size mesoporosity in the mesolitic sample is evident;

FIG. 8 depicts the physisorption isotherm of N₂ at 77 K of H-ZSM-5[MCM-41] and its zeolitic version. The pore size distribution (BJH method) of the mesostructured zeolite is included in inset. The presence of well developed narrow pore size mesoporosity in the mesolitic sample is evident;

FIG. 9 depicts pore volumes (darker columns) of H-Y[MCM-41], H-MOR[MCM-41], and H-ZSM-5[MCM-41] and their zeolitic versions (lighter columns);

FIG. 10 depicts images obtained by transmission electron microscopic of a) detail of a H-Y[MCM-41] mesostructured zeolite, and b) detail of a H-Y[MCM-41] mesostructured zeolite at different focus. The electron diffraction patterns are included as insets;

FIG. 11 depict a TEM image of a mesostructured zeolite of the present invention;

FIG. 12 depicts a TEM image of a mesostructured zeolite of the present invention;

FIG. 13 depicts catalytic cracking of 1,3,5-triisopropyl benzene to benzene by zeolite HY;

FIG. 14 depicts the process of catalytic cracking of 1,3,5-triisopropyl benzene to 1,3-diisopropyl benzene by a mesostructured zeolite of the present invention. Diisopropyl benzene was the only product detected;

FIG. 15 depicts catalytic activity for 1,3,5-triisopropyl benzene cracking shown as conversion vs. time for H-Y[MCM-41], its zeolitic version, and a conventional Al-MCM-41. A 50 mL/min of He flow saturated with 1,3,5-triisopropylbenzene at 120° C. was flowed at 200° C. over 50 mg of catalyst;

FIG. 16 depicts the catalytic cracking of 1,3,5-triisopropyl benzene with H-Y[MCM-41] to diisopropyl benzene and cumene. Compared to a commercial sample, catalytic cracking with H-Y[MCM-41] results in higher selectivity and reduction in benzene production.

FIG. 17 depicts the hydrothermal stability of H-Y[MCM-41] compared to the non-mesolytic zeolite Al-MCM-41;

FIG. 18 depicts catalytic activity for 1,3,5-triisopropyl benzene cracking shown as conversion vs. time for H-MOR[MCM-48], and its zeolitic version. A 50 mL/min of He flow saturated with 1,3,5-triisopropylbenzene at 120° C. was flowed at 200° C. over 50 mg of catalyst;

FIG. 19 depicts catalytic activity for 1,3,5-triisopropyl benzene cracking shown as conversion vs. time for H-ZSM-5[MCM-41], and its zeolitic version. A 50 mL/min of He flow saturated with 1,3,5-triisopropylbenzene at 120° C. was flowed at 200° C. over 50 mg of catalyst;

FIG. 20 depicts the conversion of 1,3,5-triisopropylbenzene versus time for H-MOR[ZNR] and H-MOR. The ratio benzene produced by H-MOR/benzene produced by H-MOR[ZNR] as a function of time is also shown. A helium flow of 50 mL/min saturated with 1,3,5-triisopropylbenzene at 120° C. was introduced over 50 mg of catalyst at 200° C.;

FIG. 21 depicts percentage of polyethylene (PE) weight lost vs. temperature for the mixtures PE:catalysts: 2:1 wt., 1:1 wt., and 1:2 wt., for H-ZSM-5[MCM-41] and H-ZSM-5;

FIG. 22 depicts the FTIR spectra of a) H-Y[MCM-41], b) NH₄-Y[MCM-41], c) NH₂(CH₂)₂NMe₃Cl, d) NH₂(CH₂)₂NMe₃-Y[MCM-41], d) Rh(PPh₃)₃Cl, and e) Rh(PPh₃)₃NH₂(CH₂)₂NMe₃-Y[MCM-41];

FIG. 23 graphically illustrates the relationship between the microporosity (<20 Å) and mesoporosity (20-80 Å) for a comparative zeolite and an inventive zeolite formed according to embodiments of the present invention;

FIG. 24 is a schematic diagram of a lab-scale reaction vessel used to carry out the hydrocracking test runs described in Example 9;

FIG. 25 graphically illustrates the relationship of conversion at 700° F. as a function of days-on-stream for each of the comparative and inventive catalyst compositions tested in Example 9 at hydrocracking pressures of 1000 and 2000 psig;

FIG. 26 graphically illustrates the relationship between normalized temperature as a function of days on stream for each of the comparative and inventive catalyst compositions tested in Example 9 at hydrocracking pressures of 1000 and 2000 psig;

FIG. 27 graphically illustrates the yield of distillate, as a function of conversion, achieved during hydrocracking of a vacuum gas oil stream at 2000 psig for comparative and inventive catalyst compositions as described in Example 9;

FIG. 28 graphically illustrates the yield of naphtha, as a function of conversion, achieved during hydrocracking of a vacuum gas oil stream at 2000 psig for comparative and inventive catalyst compositions as described in Example 9;

FIG. 29 graphically illustrates the yield of C₄, as a function of conversion, achieved during hydrocracking of a vacuum gas oil stream at 2000 psig for comparative and inventive catalyst compositions as described in Example 9;

FIG. 30 graphically illustrates the yield of distillate, as a function of conversion, achieved during hydrocracking of a vacuum gas oil stream at 1000 psig for comparative and inventive catalyst compositions as described in Example 9;

FIG. 31 graphically illustrates the yield of naphtha, as a function of conversion, achieved during hydrocracking of a vacuum gas oil stream at 1000 psig for comparative and inventive catalyst compositions as described in Example 9;

FIG. 32 graphically illustrates the yield of C₄, as a function of conversion, achieved during hydrocracking of a vacuum gas oil stream at 1000 psig for comparative and inventive catalyst compositions as described in Example 9; and

FIG. 33 graphically illustrates the yield of naphtha, as a function of conversion, achieved during hydrocracking of a vacuum gas oil at 2000 psig for the comparative catalyst and inventive catalyst 2 described in Example 9.

### DETAILED DESCRIPTION

### Definitions

For convenience, before further description of the present invention, certain terms employed in the specification, examples, and appended claims are collected here. These definitions should be read in light of the remainder of the disclosure and understood as by a person of skill in the art.

The articles “a” and “an” are used herein to refer to one or more than one (i.e., at least one) of the grammatical object of the article. By way of example, “an element” means one element or more than one element.

The term “catalyst” is art-recognized and refers to any substance that notably affects the rate of a chemical reaction without itself being consumed or significantly altered.

The terms “comprise” and “comprising” are used in the inclusive, open sense, meaning that additional elements may be included.

The term “cracking” is art-recognized and refers to any process of breaking up organic compounds into smaller molecules.

The term “including” is used to mean “including but not limited to”. “Including” and “including but not limited to” are used interchangeably.

“MCM-41” represents a Mobil composite of matter and refers to an amorphous mesoporous silica with a hexagonal pore arrangement, wherein the mean pore diameter is in the range of about 2-10 nm.

“MCM-48” represents a Mobil composite of matter and refers to an amorphous mesoporous silica with a cubic pore arrangement, wherein the mean pore diameter is in the range of about 2-10 nm.

“MCM-50” represents a Mobil composite of matter and refers to an amorphous mesoporous silica with a lamellar pore arrangement, wherein the mean pore diameter is in the range of about 2-10 nm.

The term “mesoporous” is art-recognized and refers to a porous material comprising pores with an intermediate size, ranging anywhere from about 2 to about 50 nanometers.

The term “mesostructure” is art-recognized and refers to a structure comprising mesopores which control the architecture of the material at the mesoscopic or nanometer scale, including ordered and non-ordered mesostructured materials, as well as nanostructured materials, i.e. materials in which at least one of their dimension is in the nanometer size range, such as nanotubes, nanorings, nanorods, nanowires, nanoslabs, and the like.

The term “mesostructured zeolites” as used herein includes all crystalline mesoporous materials, such as zeolites, aluminophosphates, gallophosphates, zincophosphates, titanophosphates, etc. Its mesostructure maybe in the form of ordered mesporosity (as in, for example MCM-41, MCM-48 or SBA-15), non-ordered mesoporosity (as in mesocellular foams (MCF)), or mesoscale morphology (as in nanorods and nanotubes). The notation zeolite [mesostructure] is used to designate the different types of mesostructured zeolites.

“MOR” represents a mordenite which is a zeolite comprising approximately 2 moles of sodium and potassium and approximately 1 mole of calcium in its orthorhombic crystal structure. This term also includes the acidic form of MOR which may also be represented as “H-MOR.”

“MSU-S (MFI)” represents a mesoporous material made with nanosized zeolites with a pore range of about 2-15 nm. The (MFI) refers to its structure.

“MSU-S (BEA)” represents a mesoporous material made with nanosized zeolites with a pore range of about 1-15 nm. The (BEA) refers to its structure.

“PNA” represents a semicrystallized form of MCM-41.

“SBA-15” represents mesoporous (alumino) silicas with pore diameters up to 30 nm arranged in a hexagonal manner and pore walls up to 6 nm thick.

The term “surfactant” is art-recognized and refers to any surface-active agent or substance that modifies the nature of surfaces, often reducing the surface tension of water. Cetyltrimethylammonium bromide is a non-limiting example of a surfactant.

“Y” represents a faujasite which is a zeolite comprising 2 moles of sodium and 1 mole of calcium in its octahedral crystal structure. This term also includes the acidic form of Y which may also be represented as “H-Y.”

The term “zeolite” is defined as in the International Zeolite Association Constitution (Section 1.3) to include both natural and synthetic zeolites as well as molecular sieves and other microporous and mesoporous materials having related properties and/or structures. The term “zeolite” also refers to a group, or any member of a group, of structured aluminosilicate minerals comprising cations such as sodium and calcium or, less commonly, barium, beryllium, lithium, potassium, magnesium and strontium; characterized by the ratio (Al+Si):O=approximately 1:2, an open tetrahedral framework structure capable of ion exchange, and loosely held water molecules that allow reversible dehydration. The term “zeolite” also includes “zeolite-related materials” or “zeotypes” which are prepared by replacing Si⁴⁺ or Al³⁺ with other elements as in the case of aluminophosphates (e.g., MeAPO, SAPO, ElAPO, MeAPSO, and ElAPSO), gallophosphates, zincophophates, titanosilicates, etc.

“ZSM-5” or “ZSM-5 (MFI)” represents a Mobil synthetic zeolite-5. This term also includes the acidic form of ZSM-5 which may also be represented as “H-ZSM-5.” The (MFI) relates to its structure.

A comprehensive list of the abbreviations utilized by organic chemists of ordinary skill in the art appears in the first issue of each volume of the Journal of Organic Chemistry; this list is typically presented in a table entitled Standard List of Abbreviations.

For purposes of this invention, the chemical elements are identified in accordance with the Periodic Table of the Elements, CAS version, Handbook of Chemistry and Physics, 67th Ed., 1986-87, inside cover.

Contemplated equivalents of the zeolitic structures, subunits and other compositions described above include such materials which otherwise correspond thereto, and which have the same general properties thereof (e.g., biocompatible), wherein one or more simple variations of substituents are made which do not adversely affect the efficacy of such molecule to achieve its intended purpose. In general, the compounds of the present invention may be prepared by the methods illustrated in the general reaction schemes as, for example, described below, or by modifications thereof, using readily available starting materials, reagents and conventional synthesis procedures. In these reactions, it is also possible to make use of variants which are in themselves known, but are not mentioned here.

### Synthesis of Mesostructured Zeolites

In recent years, expertise has been gained in the synthesis of zeolites with desired properties by the choice of the organic molecule used as structure directing agent (SDA), control of the synthesis conditions, and post-synthesis treatments. van Bekkum, H., Flanigen, E. M., Jacobs, P. A., Jansen, J. C. (editors) Introduction to Zeolite Science and Practice, 2nd edition. Studies in Surface Science and Catalysis, 2001, 137; Corma, A., Chem. Rev., 1997, 97, 2373-2419; Davis, M. E., Nature, 2002, 417, 813-821; Davis, M. E., et al., Chem. Mater., 1992, 4, 756-768; de Moor P-P. E. A. et al., Chem. Eur. J., 1999, 5(7), 2083-2088; Galo, J. de A. A., et al., Chem. Rev., 2002, 102, 4093-4138. At the same time, the family of ordered mesoporous materials has been greatly expanded by the use of different surfactants and synthesis conditions. Corma, A., Chem. Rev., 1997, 97, 2373-2419; Davis, M. E., Nature, 2002, 417, 813-821; Galo, J. de A. A., et al., Chem. Rev., 2002, 102, 4093-4138; Ying, J. Y., et al., Angew. Chem. Int. Ed., 1999, 38, 56-77. The family of mesostructured zeolites disclosed herein is a one-phase hybrid material consisting of a zeolitic structure with controlled mesoporosity, which bridges the gap between crystalline microporous and amorphous mesoporous materials.

The synthesis of mesostructured zeolites is applicable to a wide variety of materials. The first strategy is based on the short-range reorganization of a zeolite structure in the presence of a surfactant to accommodate mesoporosity without loss of zeolitic crystallinity. In an exemplary synthesis, a zeolite is added to a diluted NH₄OH solution containing cetyltrimethylammonium bromide (CTAB) surfactants. The mixture is hydrothermally treated at about 100 to about 200° C., about 120 to about 180° C., about 140 to about 160° C., or about 150° C. for about 20 hr or overnight during which the zeolite structure undergoes short-range rearrangements to accommodate the MCM-41 type of mesostructure. Higher surfactant concentrations and longer hydrothermal treatments would produce mesostructured zeolites with the MCM-48 type of mesostructure. After washing and drying, the resulting material is calcined in N₂ at a maximum temperature from about 500 to 600° C., or at about 550° C.; and then in air for surfactant removal. This synthetic scheme could be used to produce mesostructured zeolites with various zeolitic structures. For zeolites with a low solubility (e.g. ZSM-5), a diluted tetramethyl ammonium hydroxide (TMA-OH) or a solution of HF would be used instead of a diluted NH₄OH solution in the synthesis scheme.

The mesopore size and architecture may also be conveniently tuned by well-known techniques, such as the use of surfactants with different aliphatic chain lengths, non-ionic surfactants, triblock copolymers, swelling agents, etc. Also, post-synthesis treatments (e.g., silanation, grafting, surface functionalization, ion-exchange, immobilization of homogeneous catalysts and deposition of metal nanoclusters) could be employed to further improve the textural properties of the materials and/or modify their surface chemistry.

A second approach is based on the dissolution of a zeolite either in an acidic or basic medium, followed by hydrothermal treatment in the presence of a surfactant. Under these conditions, a mesoporous solid was obtained wherein the pore walls were amorphous initially. The pore walls are later transformed to a zeolitic phase, with or without affecting the mesoporous structure. Zeolitic nanorods (ZNRs) have been prepared by this approach in three steps: (i) basic treatment of a zeolite to produce a suspension of amorphous aluminosilicate, (ii) surfactant addition to produce MCM-41, and (iii) hydrothermal treatment of the resulting solid. During the last step, the MCM-41 mesostructure transformed first to MCM-48 and then to MCM-50, while their amorphous pore walls transformed to a crystalline zeolitic phase.

Zeolite-like materials, which represent a growing family of inorganic and organic/inorganic molecular sieves, may also be used as precursors for the synthesis of mesostructured zeolites, since the synthetic approaches described above may be adapted for a wide variety of materials.

### Structure of Mesostructured Zeolites

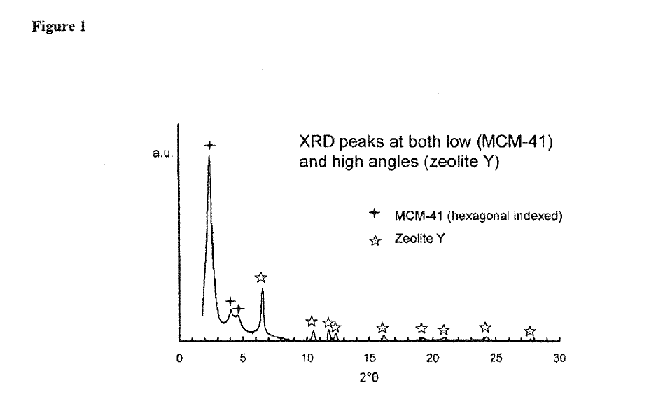

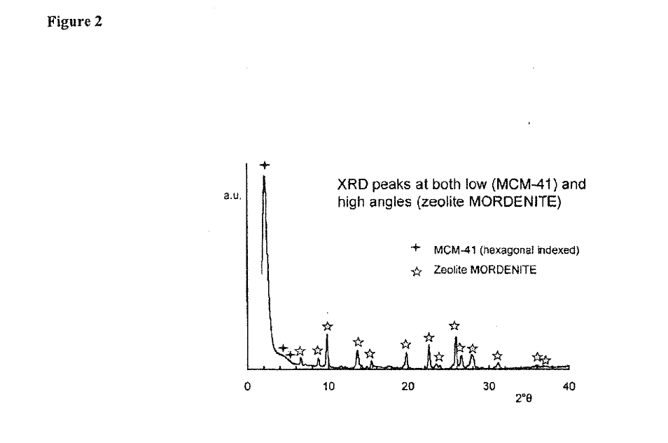

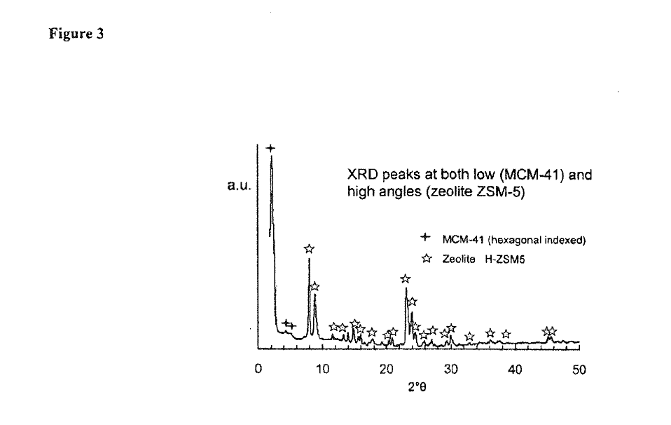

The hybrid structure of the mesostructured zeolites was studied via XRD. FIGS. 1-3 show the XRD patterns of H-Y[MCM-41], H-MOR[MCM-41], and H-ZSM-5[MCM-41], respectively. Very intense peaks, both at low and high 20° values reveal both the ordered mesostructure and the zeolitic crystallinity of this family of materials. In all cases, the peaks at low 2Θ° values can be indexed to hexagonal symmetry indicating the presence of MCM-41, whereas the well-defined XRD peaks at high 20° values correspond, respectively, to the zeolites Y, MOR and ZSM-5. This observation is remarkable since no long-range crystallinity has been previously observed in mesoporous metal oxides and only semicrystallinity (due to the presence of zeolite nanoclusters) has been achieved in thick-wall mesoporous materials prepared using triblock copolymers. Kloetstra, K. R., et al., Chem. Commun, 1997, 23, 2281-2282; Liu, Y. et al., Angew. Chem. Int. Ed. 2001, 7, 1255-1258; On, D. T., et al., Angew. Chem. Int. Ed., 2001, 17, 3248-3251.

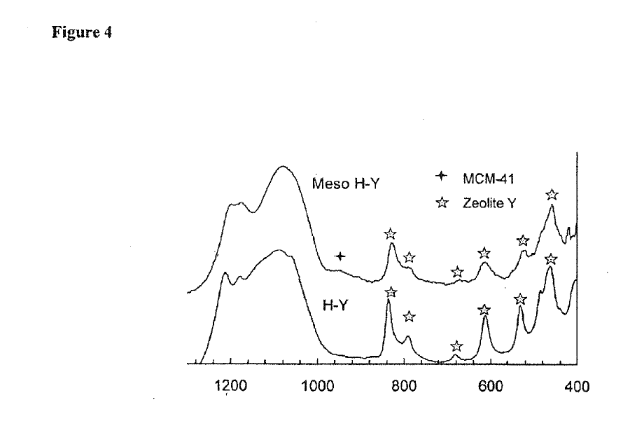

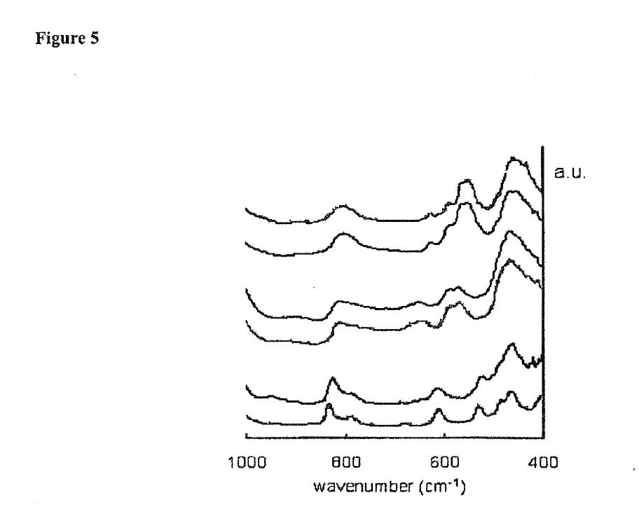

The connectivity of the mesostructured zeolites was studied by infrared spectroscopy (FTIR) (See FIGS. 4-5). FIG. 5 shows a remarkable match between the IR spectra of H-Y[MCM-41], H-MOR[MCM-41], and H-ZSM-5[MCM-41] and those of the their corresponding zeolitic versions, contrary to highly stable Al-MCM-41, which presents only one IR broad peak, due to imperfect zeolitic connectivity. Liu, Y., Pinnavaia, T. J., J. Mater. Chem., 2002, 12, 3179-3190; Kloetstra, K. R., et al., Chem. Commun, 1997, 23, 2281-2282; Liu, Y. et al., Angew. Chem. Int. Ed., 2001, 7, 1255-1258. The peak at 960 cm⁻¹ in the H-Y[MCM-41] mesostructured zeolite sample, characteristic of silanol groups on the wall surfaces, is an additional evidence of the mesoporous/zeolitic hybrid nature of mesostructured zeolites. Geidel, E., et al., Microporous and Mesoporous Materials, 2003, 65, 31-42.

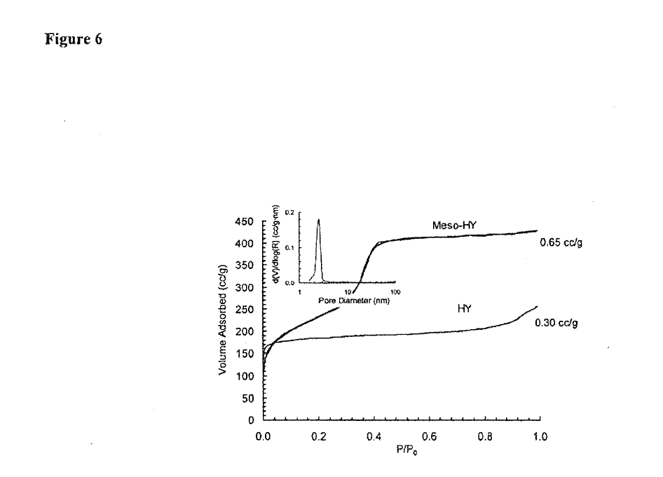

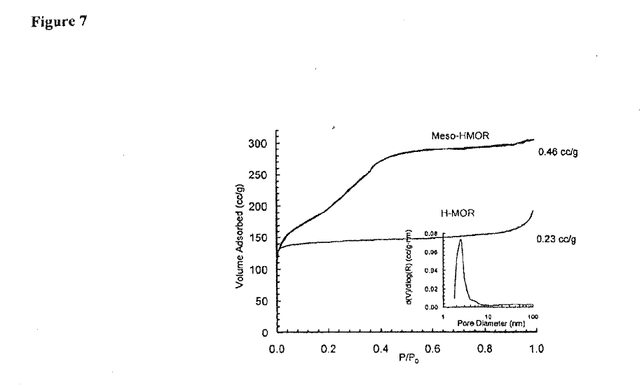

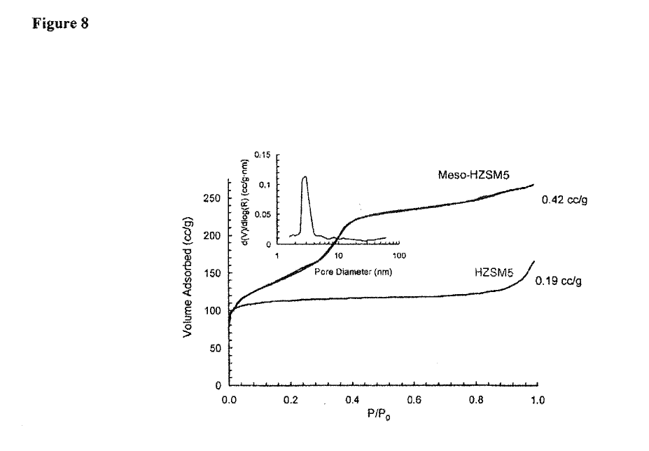

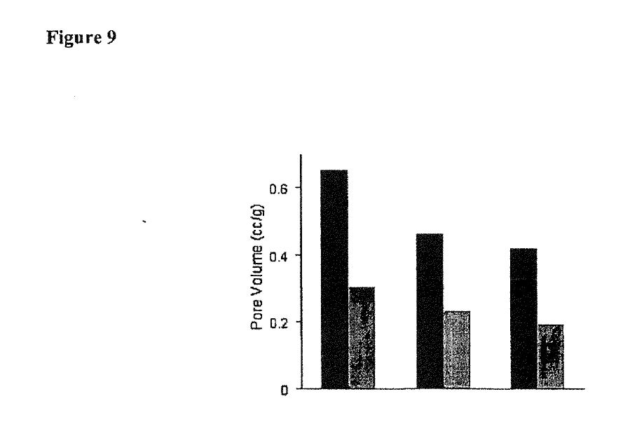

The presence of well-defined mesoporosity in mesostructured zeolites can be suitably studied by nitrogen physisorption at 77 K. Storck, S., et al., Applied Catalysis A: General, 1998, 17, 137-146. FIGS. 6-8 show the nitrogen isotherms at 77 K of H-Y[MCM-41], H-MOR[MCM-41], and H-ZSM-5[MCM-41], respectively, and their zeolitic versions. Conventional zeolites adsorb nitrogen only at low pressures, producing type I isotherms that are characteristic of microporous materials. Storck, S., et al., Applied Catalysis A: General, 1998, 17, 137-146. However, the mesostructured zeolites show sharp nitrogen uptakes at higher partial pressures (P/P₀˜0.3), which is a characteristic feature of mesostructured materials with narrow pore-size distribution (pore diameter ˜2.5 nm). Storck, S., et al., Applied Catalysis A: General, 1998, 17, 137-146. Compared to zeolites, mesostructured zeolites have more than double the pore volume (see FIG. 9) due to the incorporation of well-developed, narrow-sized mesoporosity, mesostructured zeolites have sharper uptake at low partial pressures, which indicates the presence of microporosity, and slightly higher pore size. As well known in surfactant-templated mesoporous solids synthesis, the size of the mesopore in mesostructured zeolites can be easily tuned by changing the length of the aliphatic chain of the surfactant. Corma, A., Chem. Rev. 1997, 97, 2373-2419; Linssen, T., Cassiers, K., Cool, P., Vansant, E. F., Advances in Colloid and Interface Science, 2003, 103, 121-147; Ying, J. Y., et al., Angew. Chem. Int. Ed., 1999, 38, 56-77.

Previous attempts by others to prepare zeolitic mesostructured materials led to phase separation into zeolite and amorphous mesoporous solids. Karlsson, A., et al., Microporous and Mesoporous Materials, 1999, 27, 181-192; Huang L., et al., J. Phys. Chem. B. 2000, 104, 2817-2823. Moreover, some authors pointed out the difficulty of making thin-walled mesoporous materials, such as MCM-41, with zeolitic walls, due to surface tension caused by the high curvature of the structure. Yang, P., et al., Nature, 1998, 396, 152-155.

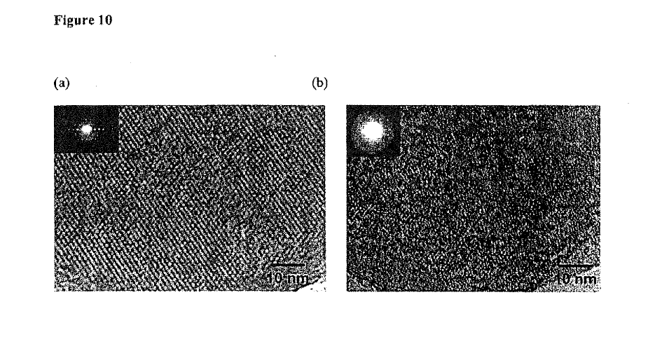

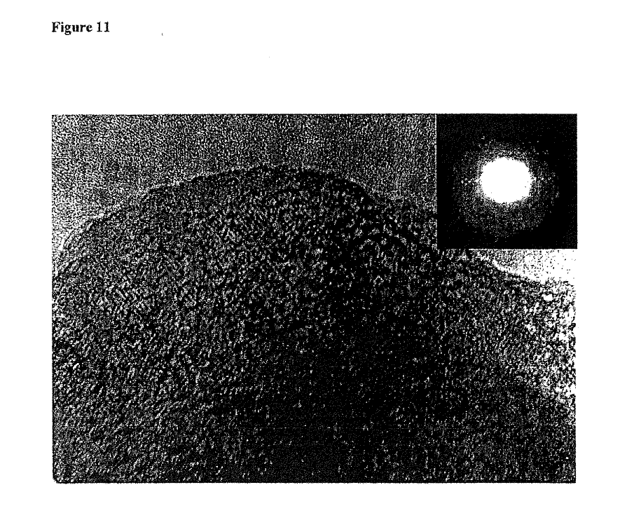

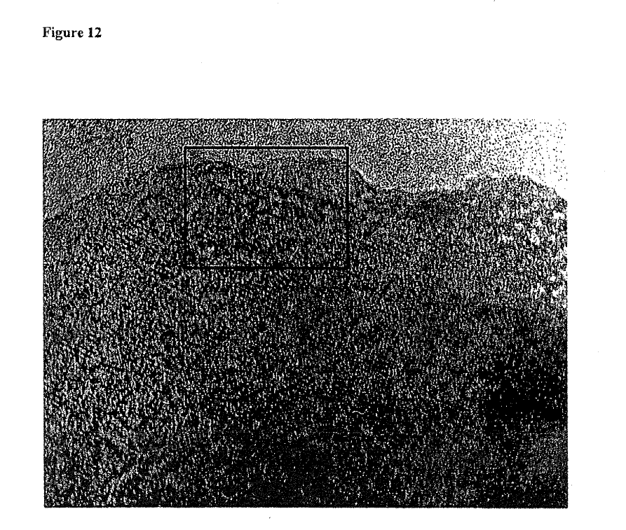

Direct evidence for the hybrid single-phase nature of mesostructured zeolites was obtained via transmission electronic microscopy (TEM). FIGS. 10a and 10b show two details of the mesostructured zeolite microstructure at different foci in which both the crystallinity and ordered mesoporosity can be observed in a single phase. Additional TEM images are depicted in FIGS. 11-12.

Additional evidence of the hybrid nature of mesostructured zeolites comes from catalysis. The presence of mesopores, high surface, and very thin walls (˜2 nm), must allow access to bulkier molecules and reduce intracrystalline diffusion. So, enhanced catalytic activity for bulky molecules must be observed in mesostructured zeolites compared to zeolites.

For example, semicrystalline mesoporous materials, such as nanocrystalline aluminosilicates PNAs and Al-MSU-S_{(MFI)}, shows significantly lower activity for cumene cracking (which is usually correlated to strong Bronsted acidity) than conventional H-ZSM-5. Mesostructured zeolites, however, show even greater activity than zeolites, most likely due to their fully zeolitic structure and the presence of mesopores. For example, H-ZSM-5 [MCM-41] converts 98% of cumene at 300° C. whereas commercial H-ZSM-5 converts 95% in similar conditions.

The anchoring of chemical species on mesostructured zeolites was confirmed by Infrared Spectroscopy (FTIR). The pure chemical species to be anchored, the mesostructured zeolites, and the species modified mesostructured zeolites prepared according the method described herein were all ananlyzed by FTIR. The species modified mesostructured zeolites exhibited the FTIR bands of the chemical species which did not disappear after washing the samples.

Some of the chemical species anchored on mesostructured zeolites were used as ligands for a homogeneous catalysts. This anchoring of a homogeneous catalyst was confirmed by Infrared Spectroscopy (FTIR), and by catalytic testing of both the homogeneous catalysts and the homogeneous catalysts anchored on the mesostructured zeolite. These experiments were repeated after washing the samples and no major changes were observed, indicating that this method is suitable for anchoring both chemical species and homogeneous catalysts.

### Applications

The unique structure of mesostructured zeolites will be useful to a variety of fields, and should address certain limitations associated with conventional zeolites. As catalysis is the most important field of application for zeolites, special emphasis is placed on the catalytic applications of mesostructured zeolites. van Bekkum, H., Flanigen, E. M., Jacobs, P. A., Jansen, J. C. (editors). Introduction to Zeolite Science and Practice, 2nd edition. Studies in Surface Science and Catalysis, 2001, Vol. 137; Corma, A., Chem. Rev. 1997, 97, 2373-2419; Davis, M. E., Nature 2002, 417, 813-821.

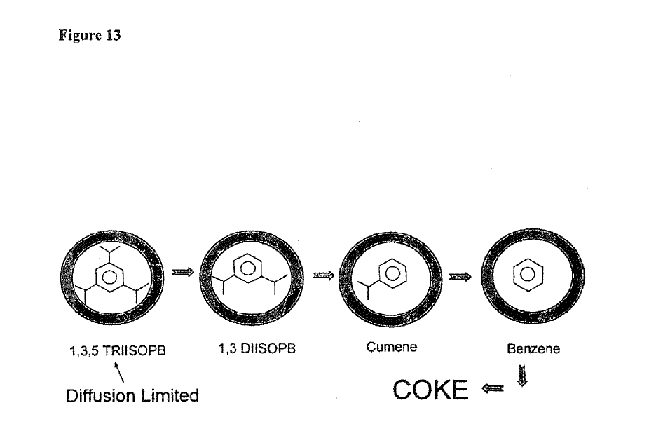

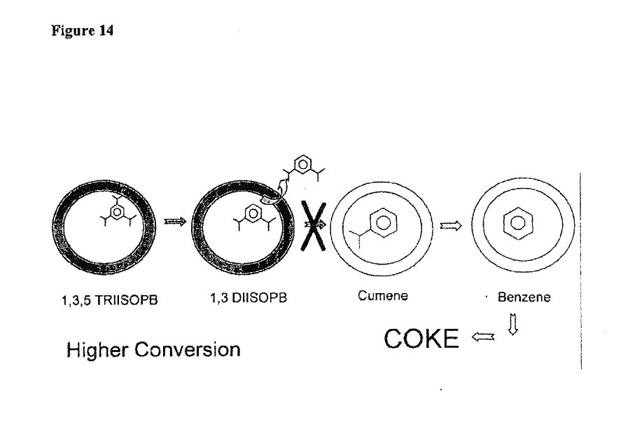

The combination of a mesostructure, a high surface-area, and thin walls (−2 nm) should provide for access to bulky molecules and reduce the intracrystalline diffusion barriers. Thus, enhanced catalytic activity for bulky molecules should be observed over mesostructured zeolites, as compared to conventional zeolites. See FIGS. 13-14.

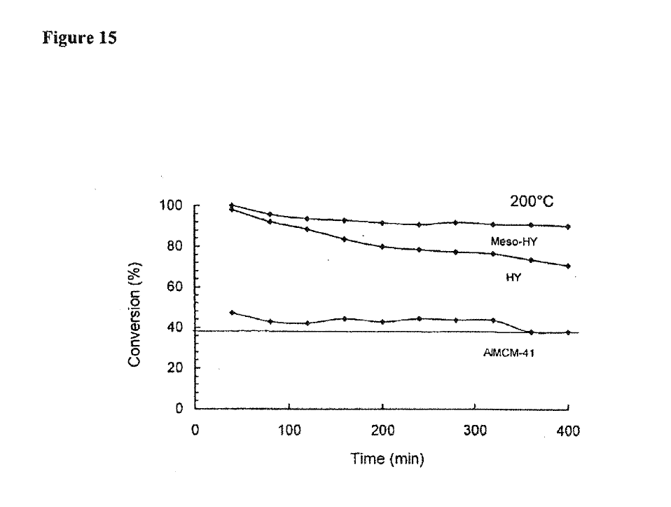

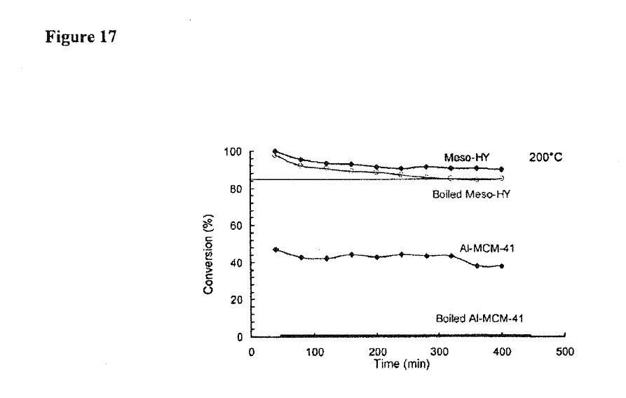

Acid catalysts with well-defined ultralarge pores are highly desirable for many applications, especially for catalytic cracking of the gas oil fraction of petroleum, whereby slight improvements in catalytic activity or selectivity would translate to significant economic benefits. Venuto, P. B., Habib, E. T., Jr. Fluid Catalytic Cracking with Zeolite Catalysts. Marcel Dekker, New York, 1979; Harding, R. H., et al., Appl. Catal. A: Gen., 2001, 221, 389-396; Degnan, T. F., et al., Microporous Mesoporous Mater., 2000, 35-36, 245-252. As a test reaction, we have examined the catalytic cracking of 1,3,5-triisopropylbenzene (critical dimension ˜0.95 nm). The H-Y[MCM-41] mesostructured zeolite demonstrated superior catalytic activity for this cracking reaction after 400 min at 200° C. (93% conversion) compared to the H-Y zeolite (71% conversion) and the mesoporous Al-MCM-41 (39% conversion) (see FIG. 15). This result was attributed to its combination of strong acidity and mesostructured nature. The mesopores greatly facilitated the hydrocarbon diffusion within the H-Y[MCM-41] catalyst. The H-Y[MCM-41] mesostructured zeolite also maintained its physicochemical integrity even after being boiled for several days, exhibiting a high 1,3,5-triisopropylbenzene activity (87% conversion after 400 min) even after such severe treatment. See FIG. 17. This outcome illustrated the superior hydrothermal stability of H-Y[MCM-41] over the amorphous Al-MCM-41 catalyst, which lost its activity and ordered mesostructure after exposure to similar conditions.

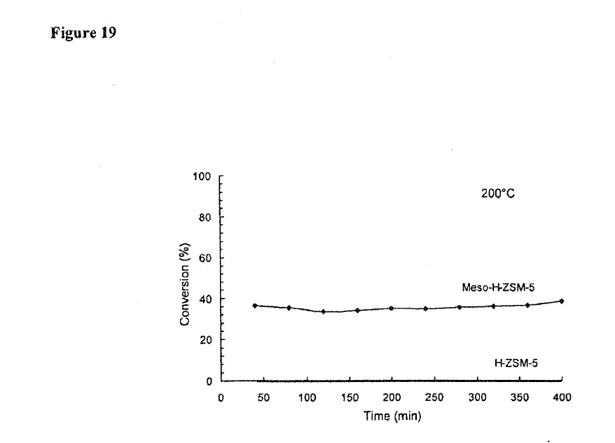

H-ZSM-5 is used as an important additive in cracking catalysts to increase propylene production and improve octane number in gasoline. Degnan, T. F., et al., Microporous Mesoporous Mater., 2000, 35-36, 245-252. However, due to its small pores, it is inactive in 1,3,5-triisopropylbenzene cracking at 200° C. (<1% conversion after 400 min). The incorporation of MCM-41 mesostructure in this zeolite (H-ZSM-5[MCM-41]) successfully achieved substantial activity, with 40% conversion after 400 min (see FIG. 19). In this case, the activity was attributed to the mesopores and strong acidity of the mesostructured zeolite.

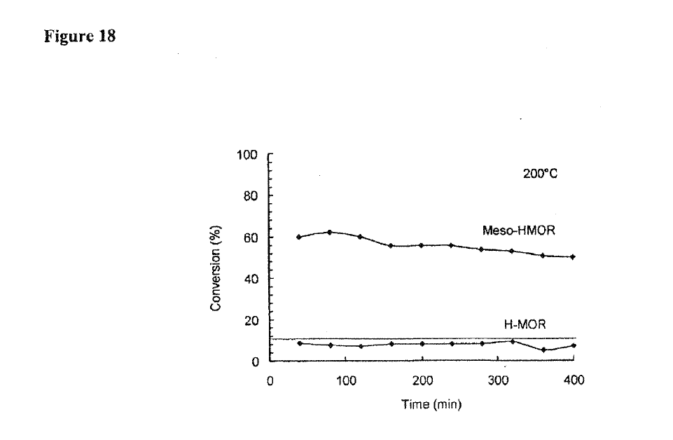

More than 135 different zeolitic structures have been reported to date, but only about a dozen of them have commercial applications, mostly the zeolites with 3-D pore structures. Corma, A., Chem. Rev., 1997, 97, 2373-2419; Davis, M. E., Nature, 2002, 417, 813-821. The incorporation of 3-D mesopores would be especially beneficial for zeolites with 1-D and 2-D pore structures as it would greatly facilitate intracrystalline diffusion. To illustrate the potential of mesostructure processing of zeolites with low pore interconnectivity, H-MOR with 1-D pores were prepared with MCM-48 mesostructure. The resulting H-MOR[MCM-48] with 3-D mesostructured structures was examined for the catalytic cracking of 1,3,5-triisopropylbenzene at 200° C. It exhibited 50% conversion after 400 min, which was significantly higher compared to the 7% conversion achieved by H-MOR (see FIG. 18).

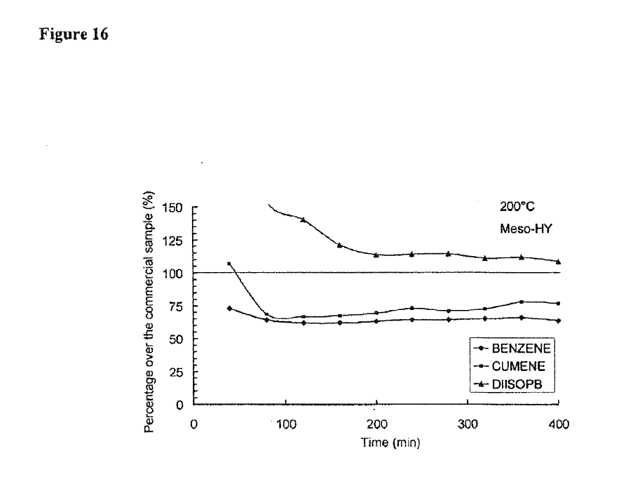

Mesostructured zeolites not only showed much higher catalytic activity, but also enhanced selectivity. For example, H-Y[MCM-41] mesostructured zeolite produced only 75% of the benzene generated by the H-Y zeolite. See FIG. 16. Benzene is a toxic compound whose presence in gasoline is being increasingly restricted by legislation. Degnan, T. F., et al., Microporous Mesoporous Mater., 2000, 35-36, 245-252. The benzene production was even lower in the case of H-MOR[MCM-48], and was minimal in the case of H-ZSM-5[MCM-41]. The decrease in benzene production has been observed in small zeolite crystals, and was related to the intrinsic ability of crystals with higher surface areas to limit successive cracking reactions. Al-Khattaf, S., et al., Appl. Catal. A: Gen. 2002, 226, 139-153. It also reduced the formation of coke, which was the undesired end-product of the cracking process that was responsible for catalyst deactivation. Thus, the mesostructured zeolites not only provided for higher catalytic activity and selectivity, but also longer catalyst life time.

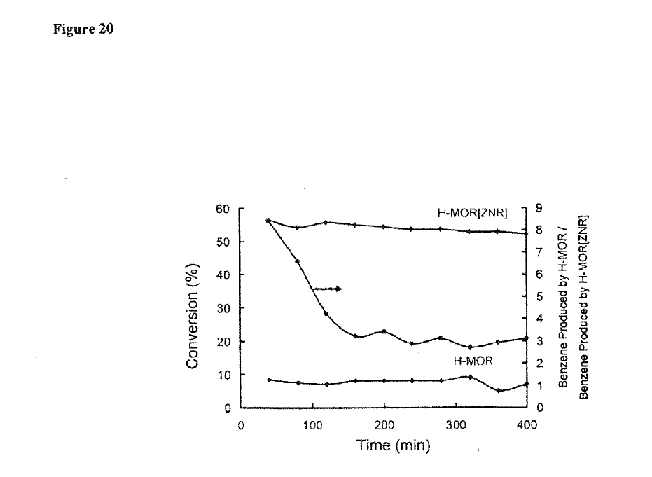

Zeolitic nanorods (ZNRs), another form of mesostructured zeolite, also enhance catalytic activity by increasing active-site accessibility. The rod-shape ZNRs are only nanometer-sized in diameter, so internal diffusional resistance is minimal. These new mesostructured zeolites were tested as cracking catalysts for the gas oil fraction of petroleum to assess their potential. In the cracking of 1,3,5-triisopropylbenzene, the conventional H-MOR zeolite showed a low activity (7% conversion after 400 min) due to its medium-sized (0.65.times.0.70 nm), 1-D pores. In contrast, H-MOR[ZNR] achieved a much higher catalytic activity under similar conditions (52% conversion) (see FIG. 20). This significant increase in catalytic activity was attributed to ZNRs' higher surface areas, readily accessible active sites, and improved intracrystalline diffusivity.

Besides increased activity, ZNRs also showed improved selectivity due to their nanostructured rod-shape morphology. For example, H-MOR[ZNR] produced 3 times less benzene per mole of 1,3,5-triisopropylbenzene converted as compared to commercial H-MOR (see FIG. 20). This significant increase in selectivity also helped to reduce coke formation, which has been a major problem with conventional cracking catalysts, especially those containing 1-D pores, such as mordenite.

The simple, inexpensive and generalized synthesis strategy described here allows for the preparation of ZNR, a crystalline material with walls that are only several nanometers thick (3-20 nm), in which nanorings and junctions are common. The novel synthesis strategy was based on the “programmed” zeolitic transformation of mesoporous materials, which avoided the typical drawbacks of nanoscaled zeolite synthesis (e.g., low yield, difficulty in separation, and high pressure drops), and did not require the use of a layered precursor. The unique crystalline structure of ZNRs provided for improved catalytic conversion of bulky molecules by increasing the accessibility to its microporosity, while reducing interparticle and intraparticle diffusion barriers.

Mesostructured zeolites were tested for crude oil refining via Microactivity Test (ASTM D-3907). This is a well known and widely accepted technique to estimate the performance of FCC (Fluid Catalytic Cracking) catalysts. Vacuum gas-oil was used as feed in a fluid-bed stainless steel reactor. The experiments were conducted under identical conditions with mesostructured zeolites and their conventional zeolites counterparts. The samples were displayed in a fluidized-bed stainless steel reactor. Reaction temperature was 500° C., the amount of catalyst was 3.0 g, the catalyst/oil ratio was 2.0, the WHSV was 30 g/h/g, and the contact time was 60 seconds. These tests showed that using HY[MCM-41] in place of conventional HY resulted in a 43% increase in gasoline production, a 75% increase in propylene and a 110% increase in butenes. Additionally, there is a 32% decrease in coke formation, a 23% decrease in Total Dry Gas, and a 12% decrease in LPG (Liquified Petroleum Gases). The presence of mesopores in the HY[MCM-41], which has double the surface area of HY, favours the cracking of the larger molecules present in the crude oil, which cannot be transformed within the micropores of conventional zeolites. The increase of light olefins was related to the reduction of hydrogen transfer reaction due to the presence of thin walls in mesostructured zeolites (˜2 nm) as opposed to. the thick crystals of conventional zeolites (˜1000 nm). This wall thickness also results in reduction of overcracking, significantly reduces coke formation, and reduces production of Total Dry Gas and LPG.

Organic feedstocks suitable for such cracking typically include mid-range boiling cuts and cracked product streams originating from various processing units within a petroleum refinery. Additionally, or in the alternative, hydrocracking of other types of organic streams is also contemplated and falls within the scope of the present invention. In one embodiment, the hydrocarbon-containing feed stream or petroleum fraction can have an initial boiling point (IBP) of at least 175° F., at least about 200° F., or at least 250° F. and/or a final boiling point of not more than about 1,200° F., not more than about 1100° F., or not more than about 1000° F., as measured by ASTM D-2887. In one embodiment, about 25 weight percent, at least about 50 weight percent, or at least about 75 weight percent of the organic or hydrocarbon-containing feedstock can have a boiling point of at least 275° F., at least 300° F., at least 325° F. and/or not more than about 850° F., not more than about 800°, not more than about 750° F. Exemplary hydrocarbon-containing feedstocks can include, but are not limited to, light gas oil, medium gas oil, heavy gas oil, light cycle oil, FCC heavy cycle oil, atmospheric distillate, visbreaker gas oil, deasphalted oil, coker gas oil, vacuum gas oil, and combinations thereof.

Pyrolysis of plastics has gained renewed attention due to the possibility of converting these abundant waste products into valuable chemicals while also producing energy. Williams, P. T. Waste Treatment and Disposal; John Wiley and Sons, Chichester, UK, 1998. Acidic catalysts, such as zeolites, have been shown to be able to reduce significantly the decomposition temperature of plastics and to control the range of products generated. Williams, P. T. Waste Treatment and Disposal. John Wiley and Sons, Chichester, UK, 1998; Park, D. W., et al., Polym. Degrad. Stability 1999, 65, 193-198; Bagri, R., et al., J. Anal. Pyrolysis, 2002, 63, 29-41. However, the accessibility of the bulky molecules produced during plastic degradation has been severely limited by the micropores of zeolites.

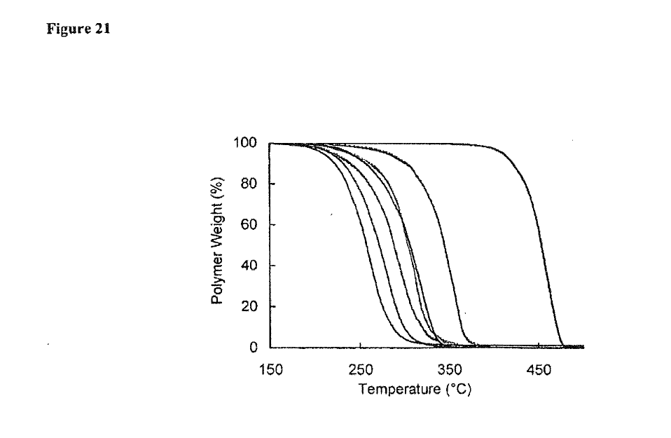

The catalytic degradation of polyethylene (PE) by commercially available zeolites and their corresponding mesostructured zeolites was studied by thermal gravimetric analysis (TGA). In all cases, mesostructured zeolites allowed for reduced decomposition temperatures compared to the commercial zeolites (by ˜35° C. in the case of H-ZSM-5[MCM-41] vs. H-ZSM-5), even at high catalyst/PE ratios (see FIG. 21). In fact, at a PE/H-ZSM-5 [MCM-41] weight ratio of 1:1, a lower decomposition temperature was achieved compared to that required by a PE/ZSM-5 weight ratio of 1:2.

The large accessible surface area and ion-exchange properties of mesostructured zeolites will also facilitate the surface functionalization, the immobilization of homogeneous catalysts, and the deposition of metal clusters. Thus, mesostructured zeolites also serve as a very useful catalyst support for a variety of reactions.

With their improved accessibility and diffusivity compared to conventional zeolites, mesostructured zeolites may also be employed in place of zeolites in other applications, such as gas and liquid-phase adsorption, separation, catalysis, catalytic cracking, catalytic hydrocracking, catalytic isomerization, catalytic hydrogenation, catalytic hydroformilation, catalytic alkylation, catalytic acylation, ion-exchange, water treatment, pollution remediation, etc. Many of these applications suffer currently from limitations associated with the small pores of zeolites, especially when bulky molecules are involved. van Bekkum, H., Flanigen, E. M., Jacobs, P. A., Jansen, J. C. (editors), Introduction to Zeolite Science and Practice, 2nd edition. Studies in Surface Science and Catalysis, Vol. 137, 2001; Corma, A., Chem. Rev., 1997, 97, 2373-2419; Davis, M. E., Nature, 2002, 417, 813-821. Mesostructured zeolites present attractive benefits over zeolites in many applications.

For example, in one embodiment, one or more of the mesostructured zeolite materials described herein may be used to form a catalyst composition for the catalytic hydrocracking of hydrocarbon-containing streams. Such catalyst compositions can include at least one catalytic metal supported on a mesoporous support material that comprises at least one of the inorganic, mesostructured crystalline materials described herein. In one embodiment, the inorganic mesostructured crystalline material used in the catalytic support can be a mesostructured zeolite and may have, for example, a unit cell size (UCS) of less than 24.300, less than 24.295, or less than 24.290, with the UCS measurements being determined by XRD and calculated using ASTM D-3942. In another embodiment, mesostructured support material used in the catalyst composition can have a framework alumina of less than about 7, less than about 6.5, less than about 6, or less than about 5.5, measured by XRD and calculated from UCS.

According to one embodiment, the mesostructured support material can have an XRD crystallinity of less than about 70 percent, less than 65 about percent, or less than about 50 percent and/or a normalized crystallinity of less than about 90 percent, less than about 85 percent, less than about 80 percent, or less than about 75 percent. Crystallinity is measured by XRD using ASTM D-3906 and normalized crystallinity is calculated by dividing the XRD crystallinity of a given material by the XRD crystallinity of CBV 100, which was used as the crystallinity standard.

In one embodiment, the inorganic mesostructured crystalline material can have a total mesopore volume (20-80 Å) of at least about 0.05 cubic centimeters per gram (cc/g), at least about 0.10 cc/g, at least about 0.15 cc/g, at least about 20 cc/g, at least about 0.25 cc/g, while optionally having a total micropore volume of up to 0.30 cc/g, up to about 0.28 cc/g, up to about 0.25 cc/g, or up to about 0.22 cc/g. In the same or another embodiment, the mesostructured crystalline material can have an extended mesopore volume (20-135 Å) of at least about 0.17 cc/g, at least about 0.20 cc/g, at least about 0.25 cc/g and/or not more than about 0.50 cc/g, not more than about 0.40 cc/g, not more than about 0.30 cc/g. The total pore volume may be at least about 0.15 cc/g, at least about 0.20 cc/g, at least about 0.25 cc/g, at least about 0.35 cc/g, at least about 0.45 cc/g, at least about 0.48 cc/g and/or not more than about 0.75 cc/g, not more than about 0.60 cc/g, or not more than about 0.55 cc/g. All porosities are determined by argon adsorption at 87K of samples outgassed under vacuum at 400° C. for 16 hours and are measured with a Quantachrome Quadrasorb instrument and the NLDFT kernel in the QuadraWin software package.

The catalytic support material of the catalyst composition can be formed by combining the inorganic mesostructured crystalline material with one or more additional support components. In one embodiment, the mesoporous support material can include at least about 15 percent, at least about 25 percent, at least about 35 percent, or at least about 50 percent and/or not more than about 99.9 percent, not more than about 99 percent, not more than about 90 percent, not more than about 85 percent, not more than about 75 percent, or not more than about 55 percent, based on the total weight of the catalyst composition, of one or more inorganic mesostructured crystalline materials, such as, for example, mesostructured zeolite materials as described herein. Optionally, the catalyst support material may include one or more binders, examples of which include, but are not limited to, alumina, silica, titania, zirconia, clays, boron oxide, and combinations thereof. When used, the binder can be present in the mesoporous support material in an amount of at least about 0.1 percent, at least about 1 percent, at least about percent, or at least about 10 percent and/or not more than about 85 percent, not more than about 75 percent, not more than about 50 percent, or not more than about 25 percent, based on the total weight of the support material.

Any suitable method may be used to prepare the support material. In one embodiment, one or more mesoporous zeolite materials as described above may be combined with one or more additional components, such as those described above. Thereafter, one or more catalytic metals can be added to the resulting mesoporous support to form the catalyst composition. Other methods of formulating a support material can be used, as long as sufficient mesoporosity of the support is retained.

The resulting mesoporous support material for use in the catalyst composition can have a total mesopore volume (20-80 Å) of at least about 0.05 cc/g, at least about 0.15 cc/g, at least about 0.20 cc/g, at least about 0.22 cc/g, at least about 0.25 cc/g, while still retaining a certain level of microporosity. In one embodiment, the mesoporous support material can have a total micropore (<20 Å) volume of up to about 0.15 cc/g, up to about 0.10 cc/g, or up to about 0.075 cc/g. The total pore volume of the mesoporous support structure can be at least about 0.400 cc/g, at least about 0.425 cc/g, or at least about 0.440 cc/g and/or the total surface area can be at least about 300 m²/g, at least about 320 m²/g, or at least about 340 m²/g, as measured by BET analysis.

Catalyst compositions used for hydrocracking hydrocarbon-containing feed streams also include at least one catalytic metal component supported on the mesoporous support material. As used herein, the term “supported on” refers to being disposed or incorporated in, on, or within at least a portion of the support material. Typically, the catalytic metal can be present in an amount of at least about 0.05 percent, at least about 1 percent, at least about 2 percent, at least about 5 percent and/or not more than about 30 percent, not more than about 25 percent, not more than about 20 percent, or not more than about 15 percent by weight of the total catalyst composition. As mentioned previously, the metal can be in any suitable physical form, including nanoparticles, clusters, or colloids, and may be incorporated into, onto, or within the mesoporous support material according to any suitable method, including those discussed in detail previously.

Catalytic metals suitable for use in the hydrocracking catalyst compositions include transition metals, rare earth metals, one or more metals selected from IUPAC Groups IVA, VIA, VIIA, and VIIIA, and combinations thereof. Specific examples of suitable catalytic metals can include, but are not limited to, nickel, cobalt, tungsten, molybdenum, palladium, platinum, ruthenium, rhenium, osmium, iridium, niobium, lanthanum, and/or cerium. Suitable combinations of metals can include nickel with one or more metals selected from the group consisting of cobalt, tungsten, and molybdenum. The metals may be in any suitable form and, in one embodiment, may be in the form of an oxide, hydroxide, and/or sulfide of one or more of the metals listed previously. For example, the catalytic metal component may include cerium oxide, cobalt oxide, and/or nickel oxide.

In one embodiment, the amount of catalytic metal or metals present in the catalyst composition can be at least about 1.5 weight percent, at least about 2 weight percent, at least about 3 weight percent, at least about 5 weight percent and/or not more than about 25 weight percent, not more than about 20 weight percent, not more than about 15 weight percent, or not more than about 12 weight percent, based on the total weight of the catalyst composition. When two or more metals are present in the catalyst composition, the ratio of one metal to one or more other of the metals can be at least about 1:1, at least about 1.5:1, at least about 2:1, or at least about 2.5:1 and/or not more than about 10:1, not more than about 8:1, not more than about 4:1, or not more than about 3:1. When multiple metals are present in the catalyst composition, each metal may be approximately the same form (e.g., both are hydroxides, oxides, or sulfides), or one or more may be in a different form.

In one embodiment, the catalyst composition may be a bifunctional composition that includes two catalytic metals, one with an acidic functionality and one with a hydrogenation functionality. In this type of catalyst, the catalyst metal can catalyze the dissociative adsorption of hydrogen, while the mesoporous support can provide the acidity. For example, in one embodiment, the support can have an acidity of at least about 0.17 meq H/g, at least about 0.20 meq H/g, at least about 0.25 meq H/g or at least about 0.30 meq H/g and/or not more than about 0.75 meq H/g, not more than about 0.65 meq H/g, or not more than about 0.50 meq H/g, measured via temperature programmed ammonia desorption using a Q50 Thermogravimetric Analyzer from TA Instruments and an automatic titrator according to the following procedure. First, the sample to be analyzed is exchanged with 20 mL of 10.5 percent ammonium chloride per 100 grams of sample. The combined mixture is allowed to stir for 30 minutes while being heated to a temperature between 40° C. and 50° C. The resulting mixture is then filtered, washed, and dried at 80° C. for 2 hours. The acidity of the support is then measured using the automatic titrator over a temperature range of ambient to 200° C. The controlled pore size and controlled mesopore surface area of the catalytic support may enhance the bifunctional activity of such catalysts, as compared to catalyst compositions utilizing conventional supports. Additionally, the controlled pore size permits processing of larger hydrocarbon materials, which may lead to more efficient cracking processes that provide better yields.

According to one embodiment, the catalyst compositions described previously can be used in a catalytic hydrocracking process. During such a process, heavier hydrocarbon-containing feed stocks, such as crude oils, gas oils, and vacuum gas oils, are contacted with one or more hydrocracking catalyst compositions as described previously in order to upgrade the heavier feedstocks into more desirable lighter fractions, such as gasoline, diesel, and even olefins. In one embodiment, the hydrocarbon-containing feed stream suitable for contacting with the hydrocracking catalyst, as described above, may be a mid- to low-range hydrocarbon stream having an initial boiling point, as measured by ASTM D-86, of at least about 120° C., at least about 150° C., or at least about 175° C. and/or not more than about 275° C., not more than about 250° C., or not more than about 225° C. In one embodiment, at least about 50 percent, at least about 75 percent, or at least about 90 percent of the hydrocarbon-containing feedstock stream can have an average boiling point of at least about 275° C., at least about 300° C., at least about 325° C. and/or not more than about 700° C., not more than about 650° C., or not more than about 600° C. Additionally, the feed stream subjected to the hydrocracking process can have an API gravity of at least about 15°, at least about 20°, or at least about 25° and/or not more than about 50°, not more than about 45°, or not more than about 40°, as measured by ASTM D-1298.

The hydrocarbon-containing feedstock can comprise aromatic components and can have, in one embodiment, a total aromatics content of at least about 10 percent, at least about 20 percent, at least about 30 percent, at least about 40 percent, or at least about 50 percent, based on the total weight of the feed stream. Examples of suitable hydrocarbon-containing feedstocks include, but are not limited to, light gas oil, medium gas oil, heavy gas oil, light cycle oil, atmospheric distillate, visbreaker gas oil, desaphalted oil, coker gas oil, FCC gas oil, and/or vacuum gas oil.

Hydrocracking of the feedstock can be carried out by contacting the hydrocarbon-containing feed stream with one or more catalyst compositions, as described previously, in the presence of hydrogen under hydrocracking conditions. In one embodiment, the hydrocracking conditions may include an average catalyst bed temperature of at least about 250° C., at least about 300° C., at least about 350° C. and/or not more than about 600° C., not more than about 550° C., or not more than about 500° C., or in the range of from about 250° C. to about 600° C., about 300° C. to about 550° C., or about 350 to about 500° C.; and/or an average pressure of at least about 500 psig, at least about 1000 psig, at least about 1200 psig, or at least about 1500 psig and/or not more than about 2500 psig, not more than about 2000 psig, or not more than about 1500 psig; and/or a reactor space velocity of at least about 0.1 h⁻¹, at least about 1 h⁻¹, or at least about 5 h⁻¹ and/or not more than about 20 h⁻¹, not more than 15 h⁻¹, or not more than 10 h⁻¹.

Any suitable type of reactor may be used in a hydrocracking process described herein, including, for example, a fixed bed reactor, a fluidized bed reactor, a moving bed reactor, or combinations thereof. In one embodiment, the hydrocracking process can be carried a fixed bed reactor having one or more beds, or stage in series. When the process is a multi-stage process, the reactor may comprise two or more reaction zones, wherein the second (or other subsequent) reaction stage employ more severe operating conditions (e.g., a higher temperature, a higher pressure, etc.) than the preceding reaction stage. Additional catalyst beds may be included upstream of the hydrocracking catalyst beds for the removal of particles, sulfur, nitrogen, or other undesired components prior to the hydrocracking step.

As a result of hydrocracking, a hydrocracked product stream having a lower boiling point, lower specific gravity, and/or lower aromatics content may be produced. In one embodiment, the cracked product stream can have a total aromatics content of at least about 10 weight percent, at least about 15 weight percent, at least about 20 weight percent, at least about 25 weight percent and/or not more than about 60 weight percent, not more than about 50 weight percent, not more than about 40 weight percent, or not more than about 30 weight percent, based on the total weight of the product stream, which may represent an overall reduction in total aromatics content of at least about 10 percent, at least about 20 percent, at least about 30 percent, at least about 40 percent, at least about 50 percent, at least about 60 percent, at least about 70 percent, at least about 80 percent, at least about 90 percent, or at least about 95 percent, based on the feedstock composition.

The cracked product stream can also be lighter, in terms of boiling point, than the feedstock, with at least about 50 weight percent, at least about 75 weight percent, or at least about 90 weight percent of the hydrocracked product stream can have a boiling point of at least about 100° C., at least about 125° C., at least about 150° C. and/or not more than about 500° C., not more than about 450° C., not more than about 400° C., or not more than about 350° C. In one embodiment, the cracked product stream may have a mid-range boiling point that is at least about 5 percent, at least about 10 percent, at least about 15 percent, at least about 20 percent and/or not more than about 60 percent, not more than about 50 percent, or not more than about 40 percent less than the mid-range boiling point of the feed stream. Suitable examples cracked product streams formed by hydrocracking can include, but are not limited to, diesel fuel, jet fuel, naphtha, low sulfur fuel oil, kerosene, liquefied petroleum gas, gasoline, and mixtures thereof. The product stream produced from the hydrocracking process may be directly used as or blended into a fuel composition, or may undergo one or more additional processes, such as distillation, isomerization, or further cracking, before being used, blended, or stored.

Organic dye and pollutant removal from water is of major environmental importance, and represents the third major use of zeolites (accounting for 80 tons of zeolites per year). Galo, J. de A. A., et al., Chem. Rev. 2002, 102, 4093-4138. However, most of the organic dyes are bulky, which make their removal slow or incomplete, requiring a huge excess of zeolites in the process. Mesostructured zeolites offer significant advantage over zeolites in organic dye and pollutant removal with their larger surface area and pore size.

### Kits

This invention also provides kits for conveniently and effectively implementing the methods of this invention. Such kits comprise any of the zeolitic structures of the present invention or a combination thereof, and a means for facilitating their use consistent with methods of this invention. Such kits provide a convenient and effective means for assuring that the methods are practiced in an effective manner. The compliance means of such kits includes any means which facilitates practicing a method of this invention. Such compliance means include instructions, packaging, and dispensing means, and combinations thereof. Kit components may be packaged for either manual or partially or wholly automated practice of the foregoing methods. In other embodiments involving kits, this invention contemplates a kit including block copolymers of the present invention, and optionally instructions for their use.

### EXAMPLES

The invention now being generally described, it will be more readily understood by reference to the following examples, which are included merely for purposes of illustration of certain aspects and embodiments of the present invention, and are not intended to limit the invention.

### Example 1

### Synthesis of H-Y[MCM-41]

First 0.79 g of H-Y (Zeolyst CBV-720 Si/Al=15) were stirred in 50 mL of a 0.37 M NH₄OH solution containing 0.55 g of CTAB, for 20 minutes, after which time the synthesis mixture was hydrothermally treated at 150° C. for 10 hours. The solid was filtered, washed, and finally ramped in nitrogen at 5° C./min until 550° C., and then switched to air for 4 hours. Similar conditions were used to calcine all of the samples. Alternatively, 1 g of H-Y (Zeolyst CBV-720 Si/Al=15) was stirred for in 30 mL of a 0.09 M tetramethylammonium hydroxide (TMA-OH) solution. Then 0.5 g of cetyltrimethylammonium bromide (CTAB) was added. After 30 minutes of stirring the suspension was hydrothermally treated for 20 hours at 150° C. Structural parameters are presented in Table 1.

### Example 2

### Synthesis of H-MOR[MCM-41]

First, 2.0 g of H-MOR (calcined Zeolyst CBV21A Si/Al=10) was stirred in 50 mL of 0.27 M TMA-OH solution. Afterwards, 1.0 g of CTAB was added. After other 30 minutes of stirring the synthesis solution was hydrothermally treated at 150° C. for 20 hours. Structural parameters are presented in Table 1.

### Example 3

### Synthesis of H-ZSM-5[MCM-41]

First, 1.0 g of NH₄-ZSM-5 (Zeolyst CBV3024E Si/Al=15) was stirred in 50 mL of 0.8 M HF solution for 4 hours. This suspension was added to a solution containing 0.69 g of CTAB, and stirred for 30 minutes. The resulting synthesis mixture was basified by slowly adding 2.5 g of a 30% NH₄OH solution. Finally, it was hydrothermally treated at 150° C. for 20 hours. Structural parameters are presented in Table 1. The wall thickness was determined by the standard method within the art by subtracting the distance between two pore centers (aₒ, obtained via X-ray diffraction) and the pore size (determined by N₂ adsorption).

TABLE 1
Structural Parameters for the Mesostructured Zeolites

| | | Pore | Wall |
|---|---|---|---|
| | aₒ (nm) | diameter (nm) | Thickness (nm) |
| H-Y[MCM-41] | 4.2 | 2.6 | 1.6 |
| H-MOR[MCM-41] | 4.7 | 2.5 | 2.2 |
| H-ZSM-5[MCM-41] | 4.8 | 2.6 | 2.2 |

### Example 4

### Catalytic cracking of cumene and 1,3,5-triisopropylbenzene

Catalytic tests were carried out in a lab-scale packed-bed catalytic reactor connected to a gas chromatograph (Hewlett Packard HP6890 Series) with a DB petrol (50 mm×0.2 mm×0.5 microns) column. In all cases, 50 mL/min of He were flowed through 50 mg of catalyst. For cumene cracking the gas flow was saturated with cumene at room temperature and the reaction temperature was 300° C. For 1,3,5-triisopropylbenzene cracking the gas flow was saturated at 120° C. and the reaction temperatures were 300° C.

### Example 5

### Polyethylene (PE) Degradation

An initial mass of about 10 mg of catalyst:PE samples with ratios 1:2, 1:1, and 2:1 were ramped in a thermogravimetric analyzer (Perkin Elmer TGA7) at 10° C./min in a 250 mL/min flow of He until 600° C. Results are depicted in FIG. 21.

### Example 6

### Chemical Species and Homogenous Anchoring on Mesostructured Zeolites

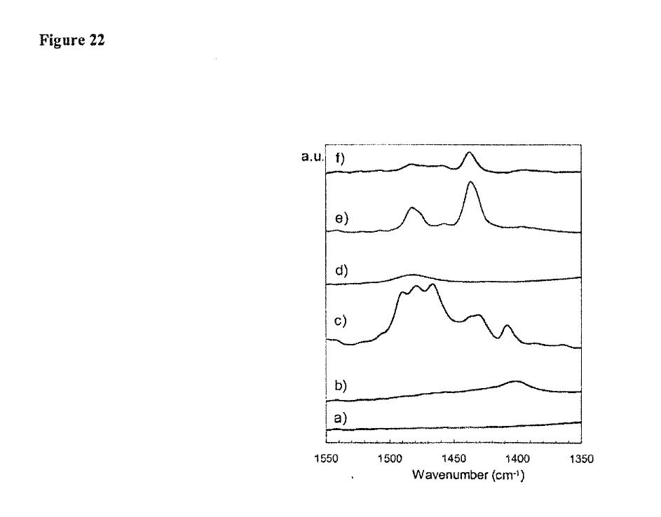

The acid form of the mesostructured zeolite with faujasite structure and MCM-41 architecture, H-Y[MCM-41], (Si/A1-15), was ion exchanged in a 0.1 M NH₄OH solution for 24 h in order to produce NH₄-Y[MCM-41]. The resulting material was ion-exchanged again in a 7.0 mM NH₂(CH₂)₂NMe₃Cl solution for 24 h. After filtering and washing thoroughly, the sample was dried at 60° C. overnight. Finally, this amine functionalized mesostructured zeolite was added to a 2.0 mM Rh(PPh₃)₃ solution (Wilkinson catalyst) for 24 h. After filtering and washing thoroughly, the sample was dried at 60° C. overnight. All the products, as well as the quartenary amine and the Wilkinson catalyst, were analyzed by FTIR to confirm the presence of the different species on the mesostructured zeolite even after thorough washing (see FIG. 22).

### Example 7

### Preparation of Zeolites for Use as Catalyst Support Materials

A first inventive mesostructured zeolite (I-Z-1) was prepared according to one embodiment of the present invention by mixing 160 g of a commercially-available zeolite, CBV-720 (available from Zeolyst International of Conoshohoken, Pa., USA) with 100 mL of deionized water and 80 g of cetyltrymethylammonium bromide (CTAB). Thereafter, 300 mL of concentrated ammonium hydroxide (NH₄OH) was added and the reaction mixture was agitated. The contents of the reaction flask were allowed to stir at room temperature for 24 hours before the solid was separated via vacuum filtration and washed with hot deionized water. The wash step was repeated two additional times. The solid was then dried at 80° C. and calcined under nitrogen at 550° C. for 2 hours. After 2 hours, the purge gas was switched to air and the temperature was gradually increased to 600° C., where it was held for 2 hours before the solid recovered.

A similar procedure was carried out to prepare another inventive zeolite (1-Z-2), except the contents of the reaction flask were agitated at a temperature of 80° C. for 24 hours. The resulting solid was filtered, washed, dried, and calcined in a similar manner as described above.

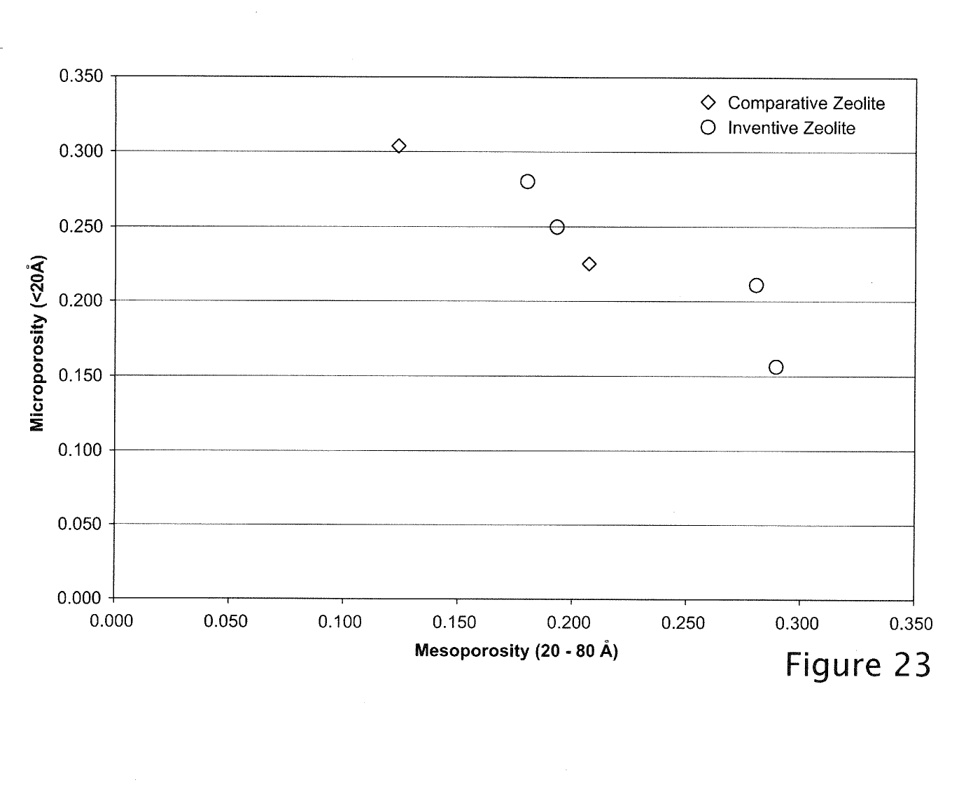

Table 2, below, compares values for several properties of inventive zeolites, I-Z-1 and I-Z-2, as well as those for the comparative base zeolite, CBV-720 (C-Z). FIG. 23 depicts the relationship of microporosity and mesoporosity for the comparative and inventive zeolite materials.

TABLE 2
Several Properties of Comparative & Inventive Zeolite Materials

| | Micropore | Mesopore | Ext. Mesopore | |
|---|---|---|---|---|
| | volume, cc/g | Volume, cc/g | Volume, cc/g | Total Pore |
| Sample | (<20 Å)¹ | (20-80 Å)¹ | (20-135 Å)¹ | volume, cc/g¹ |
| C-Z | 0.303 | 0.124 | 0.166 | 0.469 |
| I-Z-1 | 0.280 | 0.180 | 0.201 | 0.480 |
| I-Z-2 | 0.211 | 0.280 | 0.284 | 0.495 |

| | | | | Normalized | |
|---|---|---|---|---|---|
| | | Framework | Crystallinity, | Crystallinity, | Acidity, |
| Sample | UCS, Å² | Alumina³ | %⁴ | %⁵ | meq H/g⁶ |
| C-Z | 24.309 | 7.604 | 76.6 | 100 | 0.493 |
| I-Z-1 | 24.288 | 5.355 | 65.4 | 85 | 0.655 |
| I-Z-2 | 24.289 | 5.462 | 47.4 | 62 | 0.605 |

### Example 8

### Preparation of Catalyst Support Materials and Hydrocracking Catalysts

A comparative catalyst support (C-S) and several inventive catalyst supports I-S-1 through I-S-4 were prepared using various amounts of comparative zeolite C-Z and inventive zeolites I-Z-1 and I-Z-2 described in Example 7, in combination with a binder material. The resulting support materials were then impregnated with nickel oxide (NiO) and molybdenum trioxide (MoO₃) to form several different hydrocracking catalysts. Table 3, below, summarizes values for select properties the catalyst supports C-S and I-S-1 through I-S-4, while Table 4 presents values for select properties of the corresponding hydrocracking catalysts (i.e., comparative catalyst C-C and inventive catalysts I-C-1 through I-C-3), which were prepared from several of the support materials listed in Table 3.

TABLE 3
Select Properties of Inventive & Comparative Catalyst Supports

| | | Zeolite, | Surface Area, | Crystallinity |
|---|---|---|---|---|
| Support | Zeolite | wt % | m²/g | (XRD) |
| C-S | C-Z | 25 | 317 | 27 |
| I-S-1 | I-Z-2 | 40 | 365 | 27 |
| I-S-2 | I-Z-2 | 25 | 321 | 20 |
| I-S-3 | I-Z-1 | 25 | 340 | 27 |
| I-S-4 | I-Z-1 | 40 | 409 | 38 |

| | Micropore | Mesopore | Ext. Mesopore | | |
|---|---|---|---|---|---|
| | volume, cc/g | Volume, cc/g | Volume, cc/g | Total Pore | Acidity, |
| Support | (<20 Å) | (20-80 Å) | (20-135 Å) | volume, cc/g | meq H/g |
| C-S | 0.078 | 0.194 | 0.387 | 0.465 | 0.144 |
| I-S-1 | 0.083 | 0.244 | 0.375 | 0.458 | 0.414 |
| I-S-2 | 0.064 | 0.232 | 0.386 | 0.450 | 0.226 |
| I-S-3 | 0.079 | 0.215 | 0.386 | 0.465 | 0.263 |
| I-S-4 | 0.109 | 0.220 | 0.372 | 0.480 | 0.396 |

TABLE 4
Select Properties of Inventive & Comparative
Hydrocracking Catalysts

| | | | | | Surface | Crystal- |
|---|---|---|---|---|---|---|
| Cata- | Zeolite | Zeolite, | NiO, | MoO₃, | Area, | linity |
| lyst | Support | wt %¹ | wt % | wt % | m²/g | (XRD) |
| C-C | C-S | 25 | 4.6 | 13.1 | 289 | 18 |
| I-C-1 | I-S-1 | 40 | 4.3 | 11.7 | 318 | 17 |
| I-C-2 | I-S-2 | 25 | 4.4 | 12.4 | 276 | 12 |
| I-C-3 | I-S-3 | 25 | 4.4 | 13.3 | 316 | 19 |

| | | | Ext. | | |
|---|---|---|---|---|---|
| | Micropore | Mesopore | Mesopore | Total | Acid- |
| | volume, | Volume, | Volume, | Pore | ity, |
| Cata- | cc/g | cc/g | cc/g | volume, | meq |
| lyst | (<20 Å) | (20-80 Å) | (20-135 Å) | cc/g | H/g |
| C-C | 0.079 | 0.164 | 0.240 | 0.319 | 0.061 |
| I-C-1 | 0.086 | 0.212 | 0.282 | 0.368 | 0.079 |
| I-C-2 | 0.067 | 0.199 | 0.294 | 0.361 | 0.083 |
| I-C-3 | 0.088 | 0.169 | 0.272 | 0.360 | 0.064 |

Note¹:
Base concentration of zeolite in catalyst support, excluding metals. With metals, C-C, I-C-2, and I-C-3 have 21 wt % zeolite and I-C-1 has 34 wt % zeolite. I-S-1 and I-S-2 were formed with fully rived I-Z-2, while I-S-3 was formed with partially rived I-Z-1, as described in Example 8.

### Example 9

### Hydrocracking of Vacuum Gas Oil

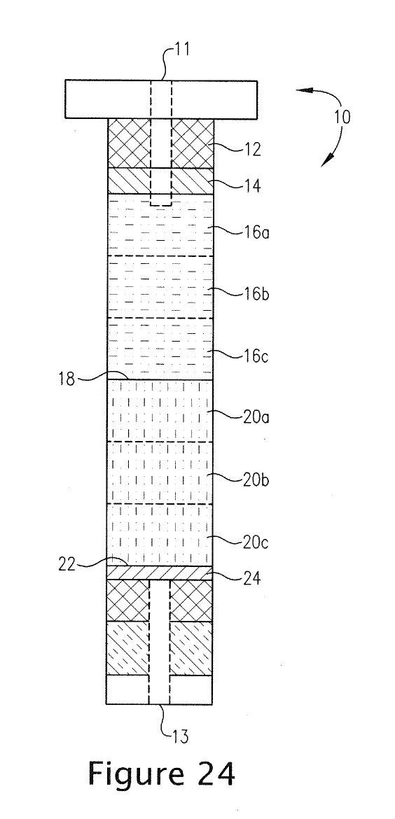

Catalytic tests were carried out on catalysts C-C and I-C-1 through I-C-3 in a lab-scale packed-bed catalytic hydrocracking reactor (a PARC 4-in-1 catalyst testing unit), a schematic depiction of which is provided in FIG. 24. As shown in FIG. 24, the reactor 10 used in the tests was a downflow, once-through vessel that included an fluid inlet 11 positioned within sequential quartz (6-8 mesh) and sand (80-120 mesh) guard beds 12 and 14, which were followed by a multi-layered pretreatment zone 16 that included catalyst beds 16a-c that include alternating layers of KF848 STARS™ hydrotreating catalyst (commercially available from Albermarle Corporation, Baton Rouge, La., USA) and sand. Disposed below the pretreatment beds 16a-c was a screen support layer 18, which included three 30, 150, and 30 mesh stacked upon one another. The reactor 10 also included a hydrocracking zone 20 including three layers 20a-c or hydrocracking catalyst disposed between intervening sand support layers. A second screen layer 22 was disposed after the hydrocracking zone 20, dividing the catalyst beds from lower quartz and sand support layers 24, 26 disposed proximate fluid outlet 13, as shown in FIG. 24.

The hydrocracking feedstock tested was vacuum gas oil (VGO) obtained from a petroleum refinery. The VGO feedstock had an API gravity of 25.2 and a specific gravity of 0.903, with 19.4 percent of the feed having a boiling point less than 700° F. The full boiling point distribution curve of the VGO feedstock is provided in Table 5, below. The feedstock had a sulfur content of 2184 ppm and a nitrogen content of 1203 ppm.

TABLE 5
Characterization of Vacuum Gas Oil used in Hydrocracking Trials

| Percent | Temperature, ° F. |
|---|---|
| IBP | 395 |
| 5 | 589 |
| 10 | 647 |
| 20 | 705 |
| 30 | 748 |
| 40 | 785 |
| 50 | 817 |
| 60 | 848 |
| 70 | 885 |
| 80 | 928 |
| 90 | 981 |
| 95 | 1020 |
| FBP | 1097 |

Prior to hydrocracking the VGO feedstock, the catalysts in testing unit 10 were presulfided by circulating 2% dimethyldisulfide (DMDS) in diesel fuel at a pressure of 800 psig. Once the desired sulfur loading was achieved, VGO was switched into the reactor and the pressure was increased to 2000 psig and held for three days. After three days, temperatures and product conversions were measured at operating pressures of 2000 psig and 1000 psig.

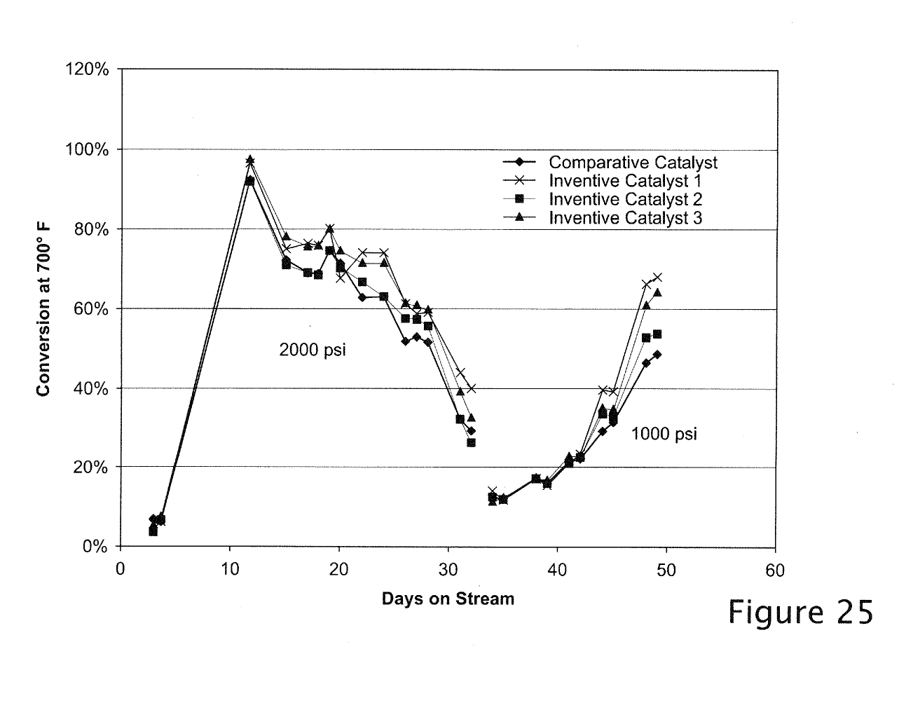

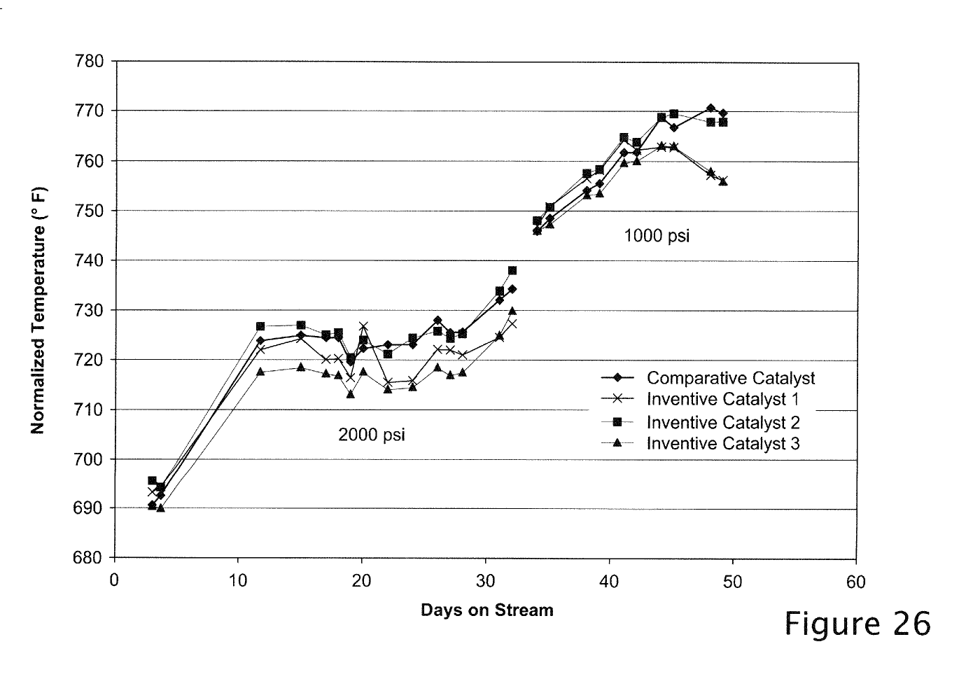

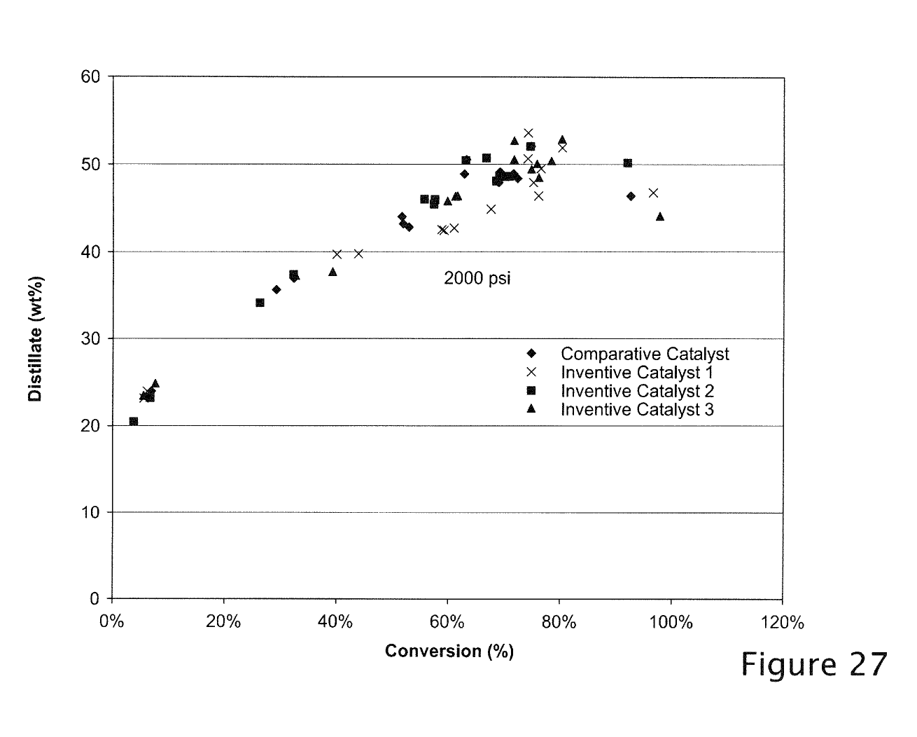

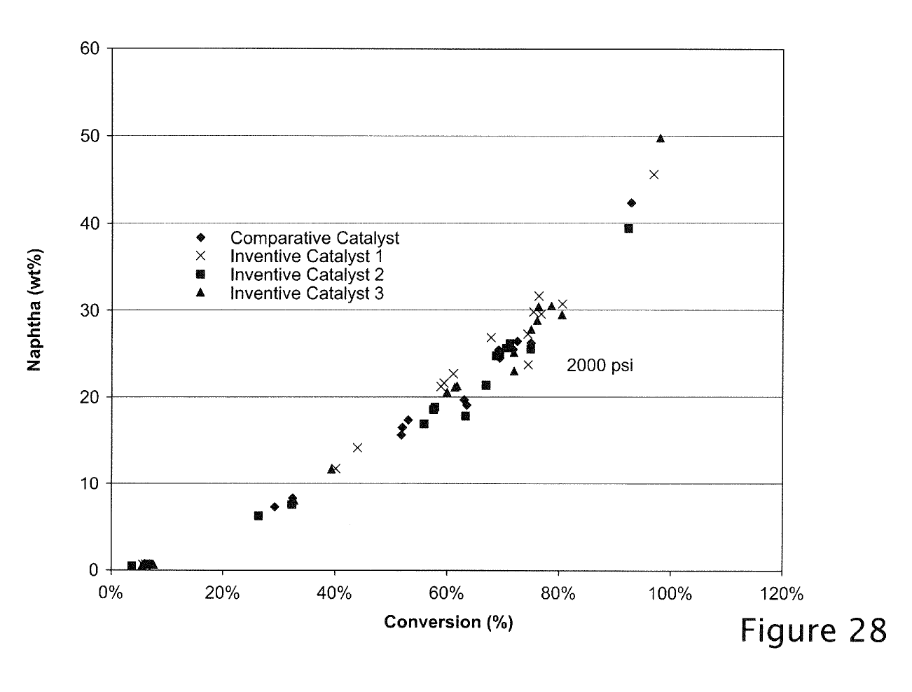

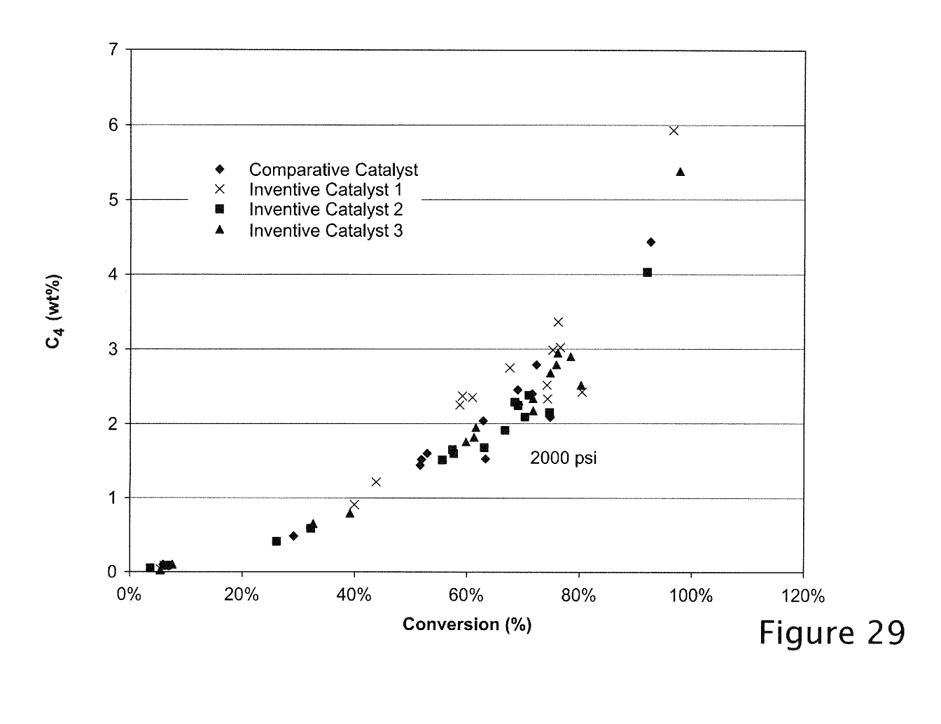

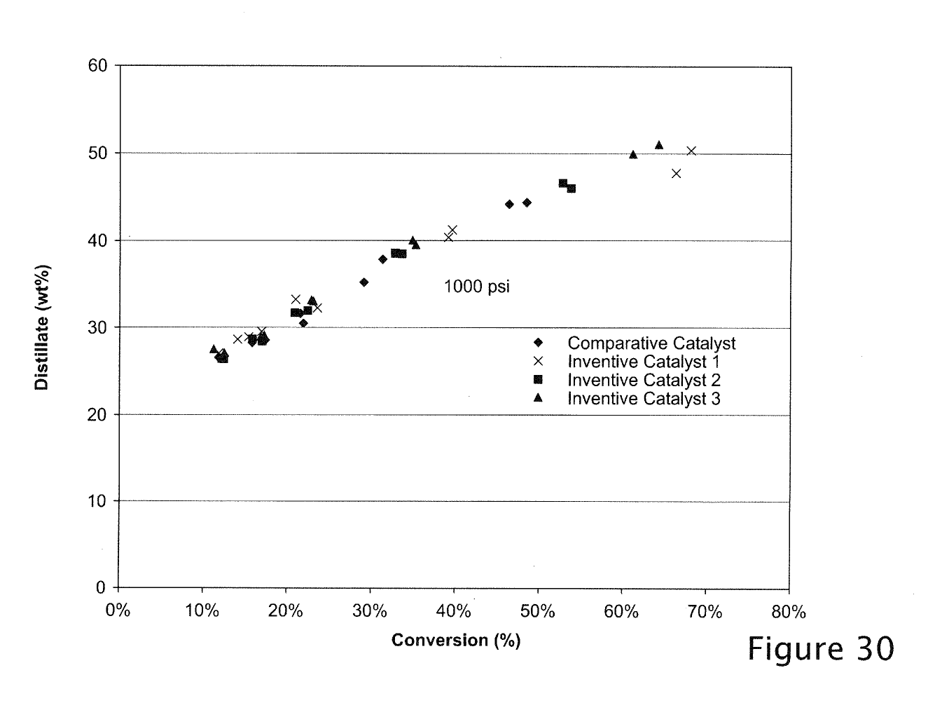

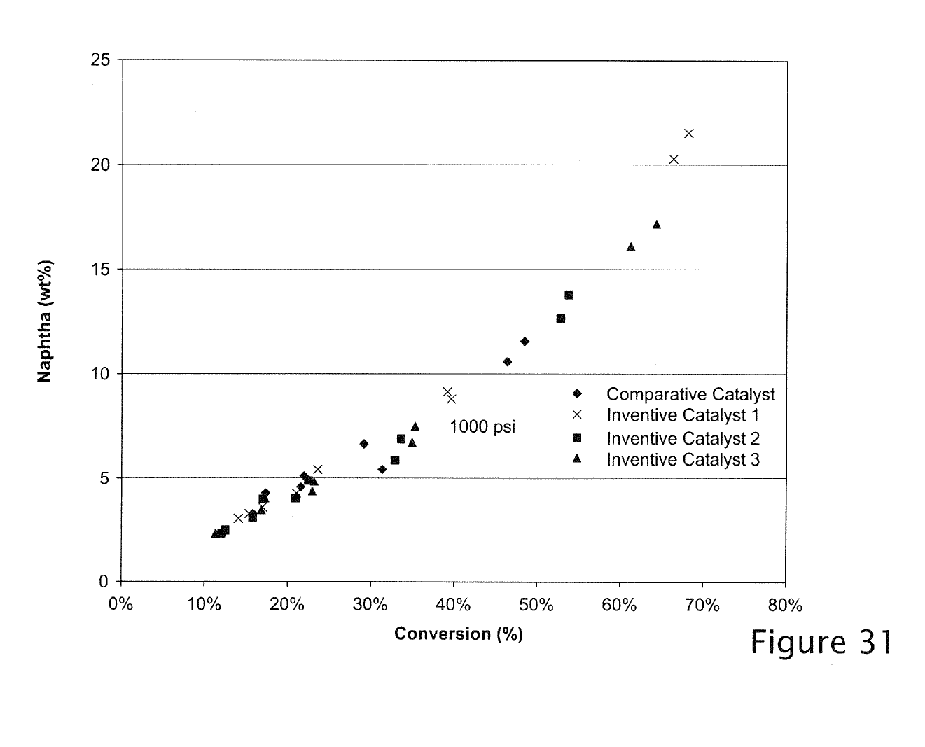

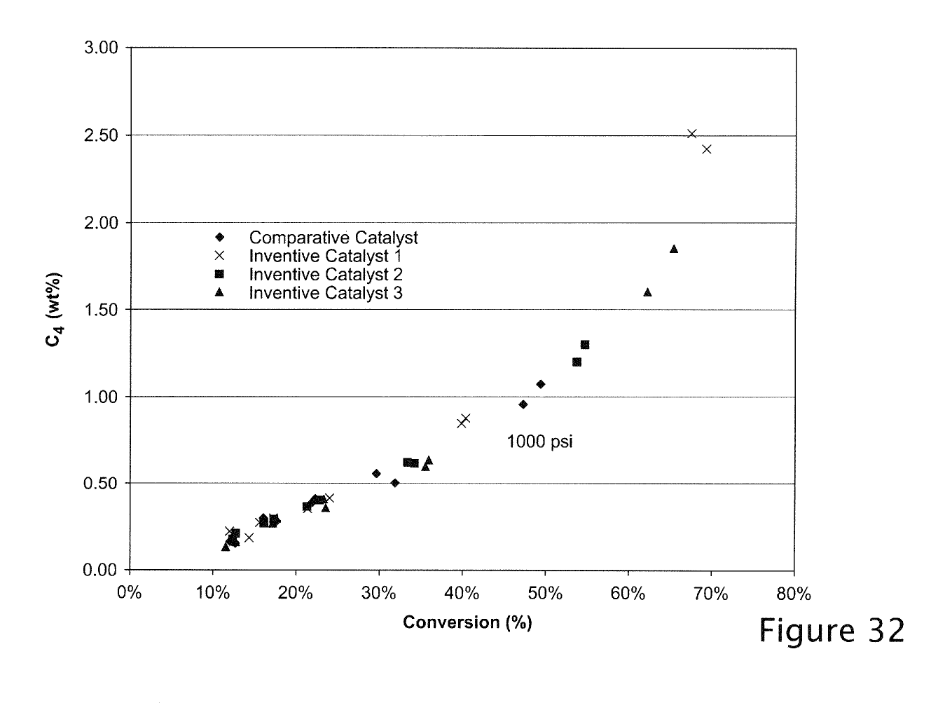

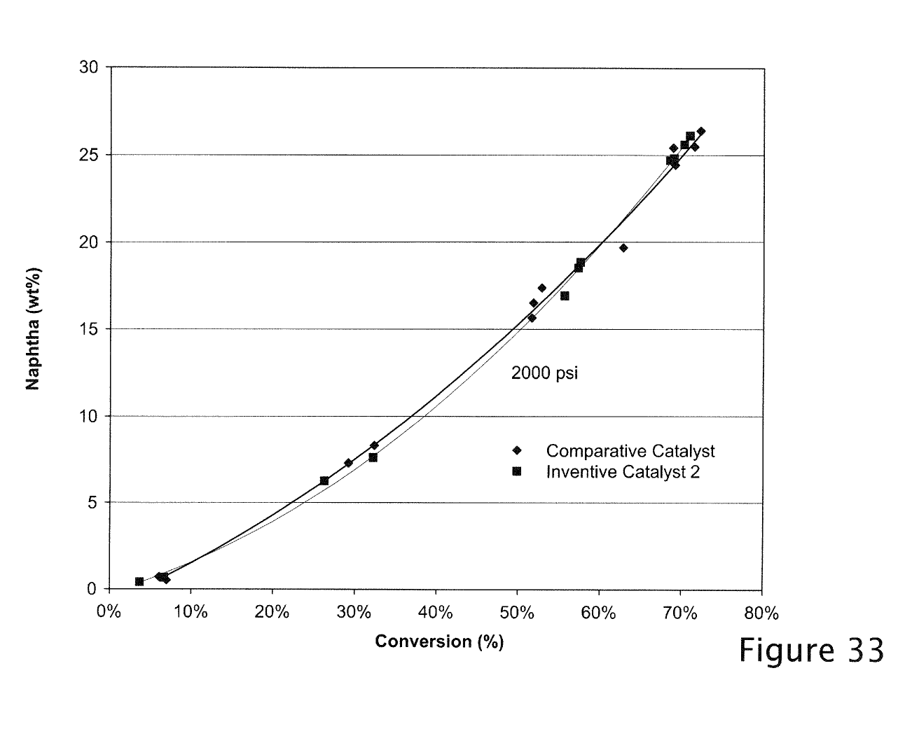

The results for actual conversion and normalized reactor temperature at 60 percent conversion, as a function of days on stream, at operating pressures of 1000 psig and 2000 psig are provided in FIGS. 25 and 26, respectively. Additionally, the respective weight percent yields of distillate, naphtha, and C₄-range material produced at 2000 psig (FIGS. 27-29) and 1000 psig (FIGS. 30-32) are also provided. FIG. 33 compares the relationship between actual conversion and naphtha yield for comparative catalyst C-C and inventive catalyst I-C-2 at 2000 psig, and Table 6, below provides a full yield comparison, at several constant conversion levels, for comparative catalyst C-C and inventive catalyst I-C-1.

TABLE 6
Yield Comparison at Set Conversion for Hydrocracking with Comparative and Inventive Catalysts

| | Conversion | | | | | | | | |
|---|---|---|---|---|---|---|---|---|---|
| | 50% Conversion (wt %) | | | 60% Conversion (wt %) | | | 70% Conversion (wt %) | | |
| | C-C | I-C-1 | Difference | C-C | I-C-1 | Difference | C-C | I-C-1 | Difference |
| Hydrogen | −1.57 | −1.57 | | −1.81 | −1.80 | | −2.05 | −2.05 | |
| C₁ & C₂ | 0.30 | 0.30 | | 0.30 | 0.30 | | 0.30 | 0.30 | |
| C₃ | 0.37 | 0.34 | −0.03 | 0.50 | 0.46 | −0.04 | 0.64 | 0.59 | −0.04 |
| C₄ | 1.39 | 1.27 | −0.12 | 1.91 | 1.74 | −0.16 | 2.51 | 2.30 | −0.21 |
| Naphtha (C₅ - 300° F.) | 15.57 | 15.24 | −0.33 | 20.21 | 20.23 | 0.02 | 25.32 | 25.90 | 0.58 |
| Distillate (300-700° F.) | 43.64 | 44.11 | 0.47 | 46.65 | 46.83 | 0.18 | 49.11 | 48.77 | −0.33 |
| Bottoms (700° F.+) | 40.30 | 40.30 | | 32.24 | 32.24 | | 24.18 | 24.18 | |
| Total | 100.0 | 100.0 | | 100.0 | 100.0 | | 100.0 | 100.0 | |
| H₂ Usage, SCF/BBL | 935 | 929 | | 1077 | 1071 | | 1219 | 1214 | |

### INCORPORATION BY REFERENCE

All of the patents and publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A hydrocracking process comprising: contacting said hydrocarbon-containing feedstock with a catalyst composition under hydrocracking conditions to thereby produce a hydrocracked product, wherein said catalyst composition comprises a mesoporous support material and at least one catalytic metal supported thereon, wherein said mesoporous support material comprises a mesostructured crystalline inorganic one-phase hybrid single crystal material having long-range crystallinity and comprising a plurality of mesopores.

2. The hydrocracking process of claim 1, wherein said crystalline inorganic material is a zeolite.

3. The hydrocracking process of claim 1, wherein said mesopores are configured in an arranged pattern, wherein the arranged pattern produces one or more distinctive XRD peaks at two theta values between 0 and 8 two theta angle degrees and one or more distinctive XRD peaks at two theta values between 0 and 8 two theta angle degrees higher than 8.

4. The hydrocracking process of claim 1, wherein said crystalline inorganic material has the structure of a faujasite (FAU), mordenite (MOR), or ZSM-5 (MFI).

5. The hydrocracking process of claim 1, wherein said crystalline inorganic material has a total mesoporous adsorption volume of at least 0.05 cubic centimeters per gram (cc/g).

6. The hydrocracking process of claim 1, wherein said crystalline inorganic material has an average pore diameter in the range of from about 2 nm to about 5 nm.

7. The hydrocracking process of claim 1, wherein said mesopores of said crystalline inorganic material have an average wall thickness in the range of from about 1 nm to about 5 nm.

8. The hydrocracking process of claim 1, wherein said mesopores of said crystalline inorganic material have a pore size distribution that is within about one-half to about double the average pore diameter of said mesopores.

9. The hydrocracking process of claim 1, wherein said catalyst composition comprises a mixture of two or more catalytic metals.

10. The hydrocracking process of claim 1, wherein said catalyst composition further comprises at least one metal oxide.

11. The hydrocracking process of claim 1, wherein said catalytic metal comprises catalytic nanoparticles.

12. The hydrocracking process of claim 1, wherein said contacting is carried out in the presence of hydrogen and wherein said hydrocracking conditions include a temperature in the range of from about 200° C. to about 480° C., a pressure of about 500 psig to about 2500 psig, and a space velocity of said hydrocarbon-containing feedstock of about 0.1 h⁻¹ to about 20 h⁻¹.

13. The hydrocracking process of claim 1, wherein said hydrocarbon-containing feedstock is selected from the group consisting of crude oil, a gas oil fraction, vacuum gas oil, and combinations thereof and said cracked product comprises gasoline and/or light olefins.

14. A hydrocracking process comprising: contacting an organic feedstock with a catalyst composition in the presence of hydrogen under hydrotreating conditions to thereby produce a hydrotreated product, wherein said catalyst composition comprises at least one catalytic component supported on a zeolitic support material, wherein said zeolitic support material comprises a single-phase crystalline mesostructured zeolite comprising a plurality of mesopores defined within of the volume of the crystalline mesostructure of said zeolite.

15. The hydrocracking process of claim 14, wherein said mesostructured zeolite has a total 20 to 80 Å diameter mesopore volume of at least 0.05 cc/g.

16. The hydrocracking process of claim 14, wherein said mesostructured zeolite has an average pore diameter in the range of from about 2 nm to about 5 nm and an average wall thickness in the range of from about 1 nm to about 5 nm.

17. The hydrocracking process of claim 14, wherein said catalytic nanoparticles comprise at least one catalytic metal.

18. The hydrocracking process of claim 17, wherein said catalytic metal is selected from the group consisting of Ni, Co, W, Mo, Pd, Pt, Ru, Rh, Os, Ir, Nb, La, Ce, and combinations thereof.

19. The hydrocracking process of claim 14, wherein said catalytic nanoparticles comprise a mixture of two or more catalytic metals, metal oxides, metal sulfides, metal hydroxides, or combinations thereof.

20. The hydrocracking process of claim 14, wherein said organic feedstock is selected from the group consisting of light gas oil, medium gas oil, heavy gas oil, LCO, atmospheric distillate, visbreaker gas oil, deasphalted oil, coker gas oil, FCC heavy cycle oil, vacuum gas oil, and combinations thereof and wherein said hydrotreated product comprises diesel fuel, jet fuel, naphtha, low sulfur fuel oil, kerosene, liquefied petroleum gas, gasoline, and mixtures thereof.
